(19) United States
(12) Patent Application Publication
(10) Pub. No.: US 2026/0278682 A1
(43) Pub. Date: Sep. 17, 2026

(54) Financial Market Prediction System: Methods and Systems for Enhanced Financial Forecasting and Market Movement Prediction Using Recognition Science

(71) Applicant: Jonathan Washburn, Austin, TX (US)

(72) Inventor: Jonathan Washburn, Austin, TX (US)

(21) Appl. No.: 19/565,322

(22) Filed: Mar. 12, 2026

Related U.S. Application Data
(60) Provisional application No. 63/771,447, filed on Mar. 13, 2025.

(51) Int. Cl. G06Q 40/04

(52) U.S. Cl. CPC G06Q 40/042

(57) ABSTRACT

A financial market prediction system is disclosed for enhanced financial forecasting and market movement prediction using a recognition-based analytical framework. Market data associated with a plurality of financial instruments is processed to determine dependency values and pairwise coupling quantities. A bounded recognition-based transform is applied to the pairwise coupling quantities to generate transformed coupling values, and a recognition-based financial network data structure is generated using the dependency values and the transformed coupling values. One or more derivative quantities associated with at least one target market variable are determined, and the bounded recognition-based transform is applied to one or more modifier inputs to generate transformed modifier values used to produce a predictive output. In certain embodiments, sentiment inputs, risk inputs, and asset-evaluation values are processed to generate bounded sentiment outputs, bounded risk outputs, and allocation outputs. The system outputs machine-generated market forecasts or market movement predictions.

### CROSS-REFERENCE TO RELATED APPLICATIONS

This application claims the benefit of U.S. Provisional Patent Application No. 63/771,447, filed Mar. 13, 2025, titled “Financial Market Prediction System: Methods and Systems for Enhanced Financial Forecasting and Market Movement Prediction Using Recognition Physics,” the disclosure of which is incorporated herein by reference in its entirety.

### BACKGROUND

The present disclosure relates generally to financial forecasting, predictive analytics, computational finance, and algorithmic trading technologies, and more particularly to computer-implemented methods, systems, and non-transitory computer-readable media for modeling financial markets as recognition-based informational structures and for generating market forecasts, market movement predictions, risk indicators, sentiment-informed signals, and portfolio allocation outputs using a recognition coverage function applied to one or more market-derived inputs.

In certain embodiments, the disclosed subject matter pertains to systems that transform price, return, volatility, liquidity, correlation, sentiment, and related financial variables into bounded analytical quantities suitable for forecasting and decision support. In certain embodiments, the disclosed subject matter pertains to systems that model inter-asset relationships as a recognition-based financial network, generate recognition-informed predictive analytics, integrate recognition-based sentiment signals, compute recognition-based risk metrics, and derive recognition-informed portfolio weights.

The disclosed subject matter may be applied in connection with equity markets, fixed-income instruments, commodities, foreign exchange markets, derivatives markets, digital asset markets, exchange-traded funds, baskets of financial instruments, indices, and other market environments in which historical, streaming, or event-driven financial information is processed to generate one or more predictive, analytical, or operational outputs.

Financial forecasting systems are widely used to estimate future price behavior, market direction, relative asset movement, risk conditions, and portfolio positioning. Existing approaches, however, often exhibit significant limitations in unstable, noisy, or rapidly changing market environments. Many conventional forecasting architectures rely on statistical assumptions, parameter estimation frameworks, or empirical tuning processes that can degrade under structural breaks, non-stationary data, volatility shocks, liquidity stress, or changing inter-asset relationships.

For example, econometric techniques such as autoregressive integrated moving average, generalized autoregressive conditional heteroskedasticity, and vector autoregression models may depend upon assumptions of stationarity, fixed structure, or stable parameter relationships that may not hold during regime shifts or crisis conditions. Such approaches may fit historical behavior adequately in some contexts but may fail to anticipate structural transitions, correlation breakdowns, or sudden coupling effects across asset classes or sectors.

Machine-learning-based financial forecasting systems, including artificial neural networks, long short-term memory networks, transformer-based architectures, and related learned models, may require large labeled datasets, substantial compute resources, extensive hyper-parameter tuning, regularization schedules, and repeated back-testing cycles. In low-signal or adversarial market environments, such systems may overfit historical data, lose interpretability, or produce outputs that lack boundedness, monotonicity, or other analytically desirable properties. In some cases, predictive performance observed in retrospective tests may not translate to live market conditions. Factor-based models, including multifactor return models and arbitrage pricing frameworks, may also present limitations. Factor definitions, sensitivities, and loadings may vary across market regimes, data windows, and asset populations. As a result, such models may require repeated recalibration and may not provide a principled mechanism for bounding forecast influence or quantifying changing market structure in a unified way.

Technical-analysis-based approaches may likewise depend on pattern recognition heuristics, chart formations, indicator thresholds, or manually selected signal conditions that can be subjective, unstable across time periods, or weakly grounded in a broader mathematical framework. Back-tested performance can overstate live effectiveness, particularly when the underlying market structure changes or when the indicators are sensitive to noise or arbitrary window choices.

Sentiment-analysis-based forecasting approaches may attempt to incorporate information from news, social media, analyst commentary, earnings calls, macroeconomic commentary, or other text-bearing sources. However, sentiment outputs are often unbounded, inconsistently normalized, model-dependent, or difficult to integrate with price-based and risk-based analytics in a unified architecture. Such systems may introduce additional normalization choices, calibration burdens, and tuning parameters.

Risk models such as value at risk, conditional value at risk, and related tail-risk frameworks may rely on distributional assumptions that underrepresent extreme events, volatility clustering transitions, correlation contagion, or liquidity-driven discontinuities. In periods of market stress, these assumptions may weaken precisely when accurate risk characterization is most needed.

Accordingly, there remains a need for improved computer-implemented systems and methods for financial forecasting and market movement prediction that can operate across different asset classes and market regimes, that can integrate heterogeneous financial inputs in a unified manner, and that can produce bounded and computationally efficient analytical outputs suitable for forecasting, risk quantification, sentiment integration, network analysis, and portfolio decision support. Recognition Science identifies a recognition-based informational optimum associated, in certain embodiments, with a scale parameter X_opt=phi/pi. In one embodiment, a recognition cost functional J(x) may be represented in plain-text form as J(x)=0.5*(x+1/x)−1, where x is a dimensionless local multiplier ratio. In certain embodiments, a recognition coverage function is defined in plain-text form as F_cov(r)=r/(r+X_opt), where r is a non-negative input quantity and X_opt is a positive scale constant. This function maps non-negative inputs into a bounded range, increases monotonically with increasing input magnitude, and can be used to regulate the influence of one or more financial variables within a forecasting architecture.

A need therefore exists for a market prediction system that applies a bounded recognition-based transform to financial variables such as volatility, liquidity, correlation-derived quantities, sentiment-related quantities, risk-related quantities, and performance-related quantities so as to generate improved market-state representations and prediction outputs. A further need exists for a system that can model inter-asset structure, dampen extreme derivative-based extrapolations, normalize sentiment influence without arbitrary scaling, generate bounded risk metrics, and support portfolio weighting in a unified computational framework.

The present disclosure addresses these and other technical problems by providing recognition-based financial forecasting systems and methods in which one or more financial inputs are transformed using a recognition coverage function and then used in network construction, predictive analytics, sentiment integration, risk quantification, portfolio allocation, and related market prediction operations.

### SUMMARY

The present disclosure provides computer-implemented methods, systems, and non-transitory computer-readable media for enhanced financial forecasting and market movement prediction using a recognition-based transform applied to one or more market-derived inputs. In certain embodiments, the disclosed subject matter provides a unified analytical framework in which price-related quantities, volatility-related quantities, liquidity-related quantities, correlation-related quantities, sentiment-related quantities, risk-related quantities, and performance-related quantities are processed through a recognition coverage function so as to generate bounded and computationally efficient outputs for forecasting, risk analysis, network analysis, sentiment integration, and portfolio decision support.

In one embodiment, a recognition coverage function is defined in plain-text form as F_cov(r)=r/(r+X_opt), where r is a non-negative input quantity and X_opt is a positive scale parameter. In certain preferred embodiments, X_opt=phi/pi. In certain implementations, X_opt may be stored as a constant, computed at runtime, stored in memory, stored in fixed-point form, stored in floating-point form, or implemented through a lookup structure or hardware logic. In certain embodiments, the use of the recognition coverage function provides a monotone bounded mapping from a non-negative input domain into a bounded output interval, thereby reducing instability associated with unbounded raw inputs.

In one aspect, the disclosed subject matter provides a recognition-based financial network in which a plurality of financial instruments are represented as nodes and inter-asset relationships are represented as edges having edge values derived from both a dependency measure and a recognition-based transform of a coupling-related quantity. In one embodiment, a network strength value is computed in plain-text form as S_ij(t)=Corr(i,j,t)*F_cov(V_ij(t)), where Corr(i,j,t) is a selected dependency measure associated with assets i and j at time t and V_ij(t) is a non-negative pairwise coupling quantity. In certain embodiments, the dependency measure comprises a correlation, covariance-derived quantity, lagged dependency quantity, factor-adjusted dependency quantity, or other relational measure, and the pairwise coupling quantity comprises volatility, covariance, realized covariance, implied volatility, liquidity-weighted coupling, or another non-negative inter-asset metric.

In another aspect, the disclosed subject matter provides a recognition-informed predictive analytics subsystem configured to generate a forecast for a target market variable using one or more recognition-scaled derivative quantities. In one embodiment, a raw first derivative is determined from time-separated observations of a target variable, a recognition-scaled first derivative is computed by multiplying the raw first derivative by F_cov(Vol(t)), and a forecast is generated using the recognition-scaled first derivative. In certain embodiments, a raw second derivative is likewise computed and scaled using F_cov(Liq(t)) or another selected recognition-compatible input. In one embodiment, a forecast may be expressed in plain-text form as P_pred(t+Delta t)=P(t)+dP_rec/dt*Delta t+0.5*d2P_rec/dt2*(Delta t)\hat{ }2. In certain embodiments, the target variable comprises price, return, spread, yield, index level, basket value, volatility, directional movement, or another market-related output variable.

In another aspect, the disclosed subject matter provides a recognition-based sentiment integration subsystem configured to ingest one or more sentiment-bearing inputs and generate a bounded sentiment signal. In one embodiment, a raw sentiment score derived from one or more text sources, communication sources, event sources, or external feeds is processed using the recognition coverage function to produce a recognition sentiment value. In one embodiment, the sentiment value is computed in plain-text form as S_market(t)=F_cov(SentimentScore(t)). In other embodiments, signed sentiment values may be processed using a signed variant of the recognition transform, including by applying a magnitude-based recognition mapping together with a sign-preserving term. The resulting sentiment output may be used alone or in combination with network outputs, forecast outputs, risk outputs, or portfolio outputs.

In another aspect, the disclosed subject matter provides a recognition-based risk quantification subsystem configured to generate a bounded risk metric from one or more risk-related inputs. In one embodiment, a realized volatility input, implied volatility input, stress volatility input, liquidity stress input, drawdown-related input, contagion-related input, or other selected risk-related quantity is processed using the recognition coverage function to produce a risk score. In one embodiment, the risk score is expressed in plain-text form as R(t)=F_cov(Vol(t)). In certain embodiments, the risk score is used for exposure reduction, hedging decisions, alert generation, stress testing, margin-related logic, collateral estimation, or rebalancing logic.

In another aspect, the disclosed subject matter provides a recognition-based portfolio allocation subsystem configured to generate adjusted portfolio weights based on one or more asset-evaluation inputs. In one embodiment, a base allocation weight w0_i associated with an asset is multiplied by a recognition-transformed quality metric to generate an intermediate weight. In one embodiment, the quality metric comprises a Sharpe ratio or related performance quantity. In one embodiment, the intermediate weight is computed in plain-text form as w_i=w0_i*F_cov(Sharpe_i). In certain embodiments, a plurality of intermediate weights are normalized to produce final allocation weights. In certain other embodiments, long-only, long-short, leverage-constrained, risk-budgeted, sector-constrained, or liquidity-constrained allocations may be generated using corresponding variations of the disclosed weighting logic.

In another aspect, the disclosed subject matter provides a combined prediction architecture in which outputs from a recognition-based financial network, a recognition-informed predictive analytics subsystem, a recognition-based sentiment subsystem, a recognition-based risk subsystem, and a recognition-based portfolio subsystem are jointly used to generate one or more market predictions, directional outputs, confidence values, alerts, rankings, or execution-related actions. In one embodiment, a combined forecast output is generated by applying one or more weighting values to subsystem outputs. In another embodiment, subsystem outputs are provided as a structured tuple or multi-component output without requiring scalar fusion. In certain embodiments, confidence values may be derived from signal agreement, neighborhood agreement, trend consistency, or subsystem concordance, and one example confidence measure may be computed using a recognition coverage function applied to a ratio of concordant signals to total considered signals.

In certain embodiments, the disclosed subject matter further provides regime-detection and contagion-detection operations. For example, a graph density measure, edge-strength distribution measure, centrality measure, clustering measure, or correlation-break measure may be monitored over time, and a regime transition may be detected when one or more such measures satisfy a selected condition. In certain embodiments, the resulting regime output may be used to modify forecast generation, risk thresholds, alert logic, hedge selection, or portfolio allocation.

In certain embodiments, the disclosed subject matter may be implemented using one or more processors, servers, cloud computing resources, graphics processors, hardware accelerators, field-programmable gate arrays, fixed-function circuitry, or combinations thereof. In certain embodiments, the disclosed subject matter may be implemented in a distributed architecture including one or more market-data ingestion modules, one or more preprocessing modules, one or more forecasting modules, one or more graph-construction modules, one or more sentiment-processing modules, one or more risk modules, one or more portfolio modules, one or more execution modules, and one or more reporting or dashboard modules. In certain embodiments, the disclosed subject matter is implemented as a software service, a locally deployed enterprise system, a co-located trading system, a workstation implementation, or a hybrid deployment.

In certain embodiments, the disclosed subject matter provides technical improvements over conventional computer-implemented financial forecasting systems by introducing a bounded, monotone recognition-based transform into multiple layers of the forecasting pipeline. In certain implementations, the bounded transform constrains intermediate values used for network edge strengths, derivative-based scaling, sentiment mappings, and risk mappings to reduce numerical instability caused by extreme or rapidly changing input magnitudes. In certain implementations, the bounded transform reduces the likelihood of overflow, underflow, saturation, and runaway amplification in streaming computations, enables consistent normalization across heterogeneous input types without ad-hoc scaling, and supports deterministic, closed-form evaluation that reduces reliance on iterative optimization loops and repeated recalibration. In certain embodiments, these properties improve machine-executed forecast generation by stabilizing intermediate computations, reducing sensitivity to noise and regime shifts, and enabling reproducible confidence-gated outputs suitable for automated downstream consumption by dashboards, APIs, and execution or risk-control modules.

In certain embodiments, the disclosed subject matter provides technical improvements over conventional systems by introducing a bounded monotone transform into multiple layers of a financial forecasting architecture. In certain implementations, this reduces sensitivity to unstable raw magnitudes, improves numerical stability, reduces computational complexity relative to optimization-heavy methods, supports efficient closed-form computation, and enables consistent treatment of heterogeneous market inputs in a unified machine-implemented framework.

In certain embodiments, one or more mathematical or logical properties of the disclosed operations may be verified, checked, certified, or otherwise validated using theorem-proving tools, symbolic reasoning tools, rule-based validators, test harnesses, or combinations thereof. In certain preferred embodiments, one or more properties associated with the recognition coverage function, network-strength computations, derivative-scaling operations, sentiment mappings, risk mappings, or portfolio-weight mappings may be machine-checked. However, such verification is optional in some embodiments, and the disclosed methods and systems may be practiced independently of any particular verification platform.

In one exemplary embodiment, the disclosed subject matter provides a method comprising receiving market data associated with a plurality of assets, computing one or more inter-asset dependency values, computing one or more recognition-transformed quantities using a recognition coverage function, generating at least one recognition-based financial network output, generating at least one recognition-informed predictive output, and outputting a market forecast, market-movement prediction, risk score, sentiment signal, allocation recommendation, regime signal, or combination thereof.

In another exemplary embodiment, the disclosed subject matter provides a system comprising one or more processors and one or more memories storing instructions that, when executed by the one or more processors, cause the system to ingest financial data, compute one or more recognition-transformed market variables, generate one or more network outputs, generate one or more forecast outputs, generate one or more risk or sentiment outputs, and provide one or more market-related outputs to a display, API, storage location, message bus, order-management system, execution engine, or user interface.

In another exemplary embodiment, the disclosed subject matter provides a non-transitory computer-readable medium storing instructions that, when executed by one or more processors, cause performance of any of the methods disclosed herein.

Additional features, aspects, and advantages of the disclosed subject matter will be apparent from the following description, drawings, and claims.

Unity of invention. In certain embodiments, the disclosed subject matter is directed to a single inventive concept implemented by one or more processors: applying a common bounded recognition-based transform (e.g., a recognition coverage function) to heterogeneous market-derived inputs and using the resulting bounded quantities to generate machine-usable outputs for market prediction. In certain embodiments, the same bounded transform is used in at least (i) recognition-based inter-asset relationship processing (including network edge weighting or related dependency-strength computations) and (ii) recognition-informed predictive analytics (including derivative-based scaling or damping operations), such that these components cooperate to produce a unified forecast and/or a confidence-gated action signal. In certain embodiments, sentiment processing, risk quantification, regime detection, and portfolio allocation are optional cooperating modules that use the same bounded transform and may be included or omitted depending on deployment requirements, while still remaining within the same single recognition-transformed prediction architecture.

### BRIEF DESCRIPTION OF THE DRAWINGS

The foregoing and other objects, features, and advantages of the disclosed subject matter will be more readily understood from the following description of certain illustrative embodiments, taken in conjunction with the accompanying drawings.

FIG. 1 is a schematic block diagram of an exemplary financial market prediction system configured to receive market and external data, generate recognition-based analytical outputs, and provide one or more forecast, risk, sentiment, network, and portfolio outputs.

FIG. 2 is a flow diagram of an exemplary method for enhanced financial forecasting and market movement prediction using a recognition-based transform applied to one or more market-derived inputs.

FIG. 3 is a schematic diagram of an exemplary recognition-based financial network in which financial instruments are represented as nodes and inter-asset dependency values are represented as edges weighted according to a recognition-transformed coupling quantity.

FIG. 4 is a flow diagram of an exemplary recognition-informed predictive analytics process in which one or more raw derivative quantities associated with a target market variable are modified using one or more recognition-transformed inputs to generate a forecast output.

FIG. 5 is a flow diagram of an exemplary recognition-based sentiment integration process in which one or more sentiment-bearing inputs are processed to generate a bounded sentiment signal.

FIG. 6 is a flow diagram of an exemplary recognition-based risk quantification process in which one or more volatility-related, liquidity-related, drawdown-related, stress-related, or contagion-related inputs are transformed to generate a bounded risk metric.

FIG. 7 is a flow diagram of an exemplary recognition-based portfolio allocation process in which one or more asset-evaluation quantities are transformed to generate adjusted portfolio weights.

FIG. 8 is a schematic block diagram of an exemplary computing environment for implementing the disclosed methods and systems, including one or more processors, memories, data interfaces, communication interfaces, and output interfaces.

### DETAILED DESCRIPTION

Reference will now be made in detail to certain illustrative embodiments of the disclosed subject matter, examples of which are depicted in the accompanying drawings. Wherever possible, the same reference numerals will be used throughout the drawings and the following description to refer to the same or like elements, features, components, operations, or structures. The disclosed embodiments are illustrative and not limiting, and the invention may be implemented in various forms, combinations, and arrangements consistent with the principles described herein.

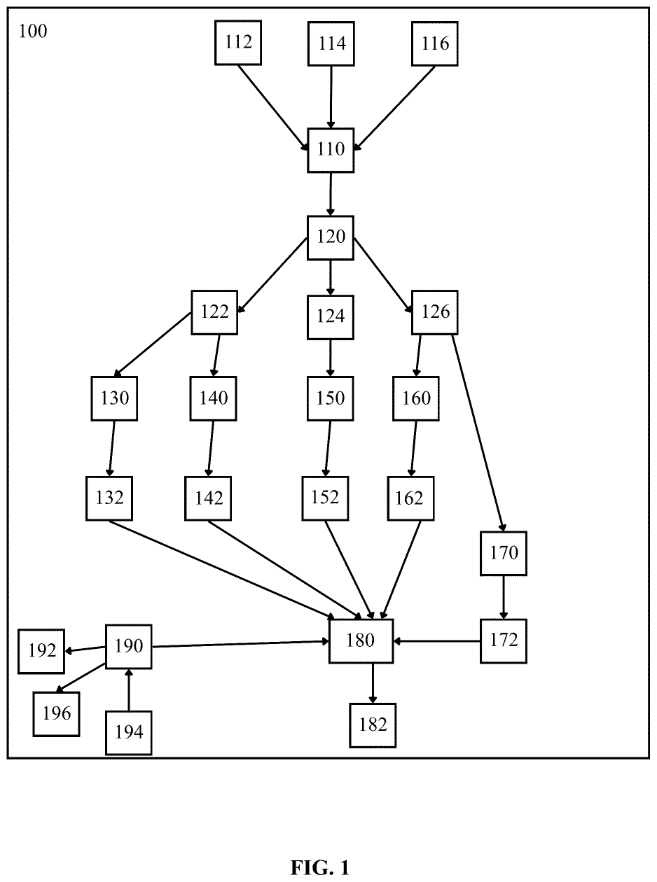

FIG. 1 illustrates an exemplary financial market prediction system 100 configured to receive market and external data, process such data using a recognition-based analytical framework, and generate one or more forecast, risk, sentiment, network, and portfolio outputs. In the illustrated embodiment, the financial market prediction system 100 includes a data ingestion subsystem 110, a preprocessing subsystem 120, a recognition-based financial network subsystem 130, a recognition-informed predictive analytics subsystem 140, a recognition-based sentiment integration subsystem 150, a recognition-based risk quantification subsystem 160, a recognition-based portfolio allocation subsystem 170, an output generation subsystem 180, and one or more data stores 190.

The data ingestion subsystem 110 is configured to receive, collect, subscribe to, poll, or otherwise obtain one or more input data streams or input datasets for use by the financial market prediction system 100. In various embodiments, the input data may include market data 112, external data 114, and system configuration data 116. The market data 112 may include, for example, price data, return data, trade data, quote data, order-book data, volume data, volatility data, options data, yield data, spread data, correlation data, covariance data, and other market-observable or market-derived quantities associated with one or more financial instruments. The external data 114 may include, for example, news data, social-media data, analyst commentary, macroeconomic data, event data, earnings-related data, fundamentals data, blockchain-related data, alternative data, and other non-price data sources relevant to market analysis. The system configuration data 116 may include one or more instrument lists, symbol mappings, sampling intervals, horizon definitions, threshold values, normalization settings, storage settings, routing settings, or other operational parameters. The preprocessing subsystem 120 is coupled to the data ingestion subsystem 110 and is configured to clean, align, normalize, transform, filter, synchronize, or otherwise prepare the received input data for downstream processing. In certain embodiments, the preprocessing subsystem 120 generates one or more prepared market variables 122, one or more prepared sentiment variables 124, and one or more prepared risk or allocation variables 126. By way of example, the preprocessing subsystem 120 may perform one or more of timestamp alignment, missing-value handling, outlier handling, resampling, rolling-window computation, scaling, volatility estimation, liquidity estimation, correlation estimation, instrument mapping, or feature extraction. In certain embodiments, one or more raw values are converted into non-negative or otherwise recognition-compatible inputs for use in one or more recognition-based transformations described herein.

The recognition-based financial network subsystem 130 is configured to generate one or more network outputs 132 based on inter-asset relationships among a plurality of financial instruments. In one embodiment, the recognition-based financial network subsystem 130 receives selected prepared market variables 122 and computes one or more dependency measures and one or more recognition-transformed coupling values for use in constructing a network representation. In one embodiment, a network edge strength between asset i and asset j at time t is computed in plain-text form as S_ij(t)=Corr(i,j,t)*F_cov(V_ij(t)), where Corr(i,j,t) is a selected dependency measure and V_ij(t) is a non-negative pairwise coupling quantity. In certain embodiments, the resulting network outputs 132 may include one or more adjacency matrices, weighted edge lists, graph density values, centrality values, clustering-related values, contagion indicators, sector linkage indicators, or other network-derived outputs.

The recognition-informed predictive analytics subsystem 140 is configured to generate one or more predictive outputs 142 for one or more target market variables. In one embodiment, the recognition-informed predictive analytics subsystem 140 receives selected prepared market variables 122 and computes one or more derivative-related quantities, momentum-related quantities, trend-related quantities, or forecast-related quantities. In one embodiment, a raw first derivative may be computed in plain-text form as dP_raw/dt=(P(t)−P(t−Delta t))/Delta t, and a recognition-scaled first derivative may be computed in plain-text form as dP_rec/dt=dP_raw/dt*F_cov(Vol(t)). In certain embodiments, a raw second derivative may be computed in plain-text form as d2P_raw/dt2=(P(t)−2P(t−Delta t)+P(t−2Delta t))/(Delta t)\hat{ }2, and a recognition-scaled second derivative may be computed in plain-text form as d2P_rec/dt2=d2P_raw/dt2*F_cov(Liq(t)). In one embodiment, a predictive output 142 may be generated in plain-text form as P_pred(t+Delta t)=P(t)+dP_rec/dt*Delta t+0.5*d2P_rec/dt2*(Delta t)\hat{ }2. In other embodiments, the predictive outputs 142 may include directional forecasts, return forecasts, spread forecasts, yield forecasts, volatility forecasts, regime forecasts, or ranking outputs.

The recognition-based sentiment integration subsystem 150 is configured to generate one or more sentiment outputs 152 based on one or more sentiment-bearing inputs. In one embodiment, the recognition-based sentiment integration subsystem 150 receives selected prepared sentiment variables 124 derived from one or more textual, event-based, social, analyst, or other sentiment-bearing sources and transforms one or more sentiment-related values into bounded outputs. In one embodiment, a recognition sentiment value may be computed in plain-text form as S_market(t)=F_cov(SentimentScore(t)). In certain other embodiments, a signed sentiment input may be processed using a sign-preserving transform based on a magnitude-normalized recognition mapping. The sentiment outputs 152 may be used independently or in combination with one or more network outputs 132, predictive outputs 142, risk outputs 162, or allocation outputs 172.

The recognition-based risk quantification subsystem 160 is configured to generate one or more risk outputs 162 based on one or more risk-related inputs. In one embodiment, the recognition-based risk quantification subsystem 160 receives selected prepared risk or allocation variables 126 and computes one or more recognition-based risk values from realized volatility values, implied volatility values, liquidity stress values, drawdown-related values, contagion-related values, spread-related values, or other selected risk-related inputs. In one embodiment, a recognition risk value may be computed in plain-text form as R(t)=F_cov(Vol(t)). In certain embodiments, the risk outputs 162 may be used for alert generation, position sizing, exposure control, hedge recommendation, portfolio overlay logic, scenario analysis, or stress escalation handling.

The recognition-based portfolio allocation subsystem 170 is configured to generate one or more allocation outputs 172 associated with a plurality of assets, baskets, or instruments. In one embodiment, the recognition-based portfolio allocation subsystem 170 receives selected prepared risk or allocation variables 126 and optionally one or more predictive outputs 142, one or more sentiment outputs 152, or one or more risk outputs 162. In one embodiment, a base weight associated with an asset may be adjusted according to a recognition-transformed quality value. For example, an intermediate allocation value may be computed in plain-text form as w_i=w0_i*F_cov(Q_i), where w0_i is a base weight and Q_i is a selected asset-evaluation quantity. In certain embodiments, Q_i may comprise a Sharpe ratio, a risk-adjusted return value, a confidence-weighted forecast value, a momentum-related value, a liquidity-adjusted performance value, or another selected quantity. In certain embodiments, a plurality of intermediate allocation values may be normalized to generate final allocation outputs 172.

The output generation subsystem 180 is configured to generate one or more system outputs 182 using one or more outputs from the recognition-based financial network subsystem 130, the recognition-informed predictive analytics subsystem 140, the recognition-based sentiment integration subsystem 150, the recognition-based risk quantification subsystem 160, and the recognition-based portfolio allocation subsystem 170. In various embodiments, the system outputs 182 may include one or more market forecasts, directional signals, confidence values, alert messages, rankings, watchlist outputs, execution-related recommendations, hedge recommendations, portfolio rebalance recommendations, dashboards, reports, stored records, or transmitted messages. In certain embodiments, the output generation subsystem 180 combines a plurality of subsystem outputs according to one or more aggregation rules, weighting rules, selection rules, voting rules, or confidence rules.

The one or more data stores 190 may include any suitable storage arrangement for storing input data, intermediate data, historical data, model states, graph states, configuration information, output records, audit records, or other system data. In certain embodiments, the one or more data stores 190 store historical market data 192, derived analytical data 194, and output or audit data 196. In certain embodiments, historical market data 192 includes time-series data for prices, returns, volumes, volatilities, spreads, and other market-observable variables. In certain embodiments, derived analytical data 194 includes transformed quantities, graph values, derivative values, risk values, sentiment values, and allocation values. In certain embodiments, output or audit data 196 includes generated reports, alerts, execution-related messages, portfolio recommendations, and historical output traces.

In operation, the financial market prediction system 100 receives one or more input datasets through the data ingestion subsystem 110, processes the received data using the preprocessing subsystem 120, and provides processed information to one or more downstream analytical subsystems. The recognition-based financial network subsystem 130 generates network outputs 132 representative of structural relationships among assets. The recognition-informed predictive analytics subsystem 140 generates predictive outputs 142 associated with one or more forecast horizons. The recognition-based sentiment integration subsystem 150 generates sentiment outputs 152 representative of bounded sentiment influence. The recognition-based risk quantification subsystem 160 generates risk outputs 162 representative of bounded risk quantities. The recognition-based portfolio allocation subsystem 170 generates allocation outputs 172 representative of one or more suggested or computed portfolio positions. The output generation subsystem 180 then generates one or more system outputs 182 for storage, display, transmission, or downstream action.

In certain embodiments, one or more of the subsystems shown in FIG. 1 may be implemented as software modules, hardware modules, firmware modules, microservices, containers, libraries, pipelines, distributed services, logic blocks, or combinations thereof. In certain embodiments, one or more subsystems may be combined with one another, subdivided into additional components, omitted, or supplemented with additional functionality. For example, in certain implementations the recognition-based risk quantification subsystem 160 and the recognition-based portfolio allocation subsystem 170 may share one or more feature computation stages, and in certain implementations the output generation subsystem 180 may be integrated with an execution management system, dashboard system, or external application programming interface.

In certain embodiments, the recognition coverage function F_cov(r) is used across multiple subsystems to provide a bounded monotone transformation of one or more non-negative inputs. In one embodiment, the recognition coverage function is defined in plain-text form as F_cov(r)=r/(r+X_opt), where X_opt is a positive scale constant. In certain preferred embodiments, X_opt=phi/pi. In certain embodiments, the use of the recognition coverage function in multiple subsystems enables a common recognition-based scaling mechanism to be applied across network construction, predictive scaling, sentiment integration, risk quantification, and allocation logic, thereby promoting computational consistency and boundedness across the architecture of the financial market prediction system 100.

Although FIG. 1 illustrates one exemplary arrangement of the financial market prediction system 100, the disclosed subject matter is not limited to the particular layout shown. One or more modules may be executed locally, remotely, in a cloud environment, in a co-located trading environment, on one or more servers, on one or more processors, or on one or more hardware accelerators. One or more data flows may be batch-based, stream-based, event-driven, request-driven, scheduled, or hybrid. One or more outputs may be consumed by human users, automated services, external applications, storage systems, order routing systems, or monitoring systems.

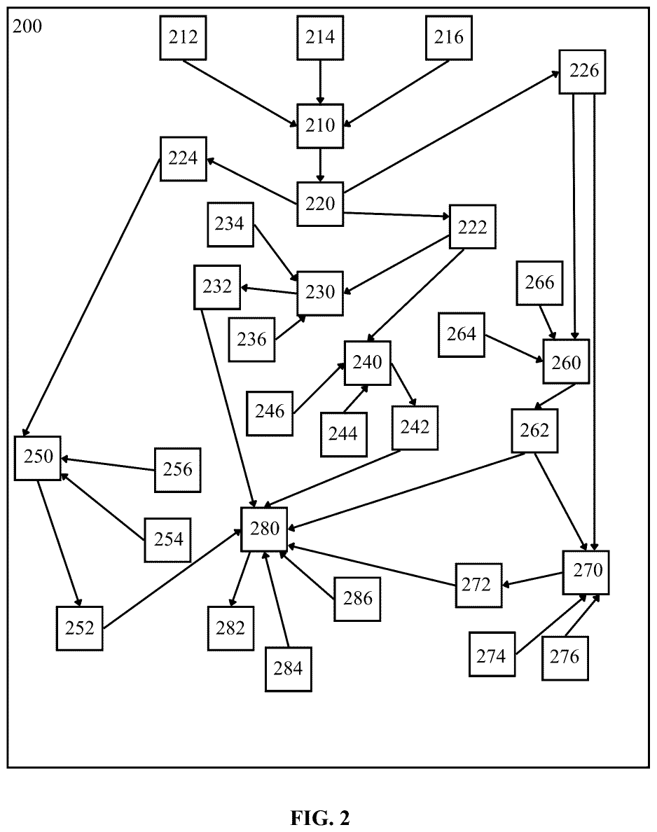

FIG. 2 illustrates an exemplary method 200 for enhanced financial forecasting and market movement prediction using a recognition-based transform applied to one or more market-derived inputs. In the illustrated embodiment, the method 200 includes a data acquisition step 210, a preprocessing step 220, a network generation step 230, a predictive analytics step 240, a sentiment integration step 250, a risk quantification step 260, a portfolio allocation step 270, and an output generation step 280. In certain embodiments, one or more of the steps of the method 200 may be omitted, reordered, combined, subdivided, repeated, or supplemented with additional operations depending on implementation details, market context, latency requirements, or output objectives.

In the data acquisition step 210, the method 200 includes receiving, retrieving, subscribing to, polling, loading, or otherwise obtaining one or more input datasets for use in the financial market prediction system 100. In various embodiments, the acquired data may include market data 212, external data 214, and configuration data 216. The market data 212 may include prices, returns, trade records, quote records, order-book records, bid-ask spread data, volume data, realized volatility data, implied volatility data, option-related data, yield-related data, spread-related data, and other market-observable or market-derived inputs associated with one or more assets or instruments. The external data 214 may include news data, social-media data, event data, analyst commentary, earnings-related information, macroeconomic releases, blockchain-related data, reference data, or alternative data. The configuration data 216 may include instrument universes, asset lists, thresholds, routing information, horizon selections, update intervals, normalization parameters, storage selections, and user-defined or system-defined operating parameters.

In the preprocessing step 220, the method 200 includes cleaning, filtering, aligning, normalizing, transforming, or otherwise preparing the acquired data for downstream analytical operations. In the illustrated embodiment, the preprocessing step 220 generates prepared market inputs 222, prepared sentiment inputs 224, and prepared risk or allocation inputs 226. In certain embodiments, the preprocessing step 220 may include one or more of de-duplication, time alignment, interpolation, missing-value handling, outlier handling, smoothing, rolling-window calculations, symbol reconciliation, session-based segmentation, unit harmonization, volatility estimation, liquidity estimation, dependency estimation, and feature extraction. In certain embodiments, the preprocessing step 220 further includes converting one or more raw inputs into one or more recognition-compatible values suitable for use with a recognition coverage function or another bounded transform.

In certain embodiments, converting raw inputs into recognition-compatible values may include mapping a raw value x_raw into a transformed value r using a preprocessing function h. In one embodiment, this may be represented in plain-text form as r=h(x_raw). In various embodiments, the preprocessing function h may include absolute-value mapping, scaling by a reference value, clipping, winsorization, min-shift normalization, percentile mapping, volatility scaling, liquidity scaling, logarithmic scaling, square-root scaling, rolling normalization, or another selected transformation. In certain embodiments, the transformed value r is non-negative and is subsequently processed using the recognition coverage function F_cov(r)=r/(r+X_opt).

In the network generation step 230, the method 200 includes generating one or more network outputs 232 representative of structural relationships among a plurality of financial instruments. In one embodiment, the network generation step 230 includes computing one or more dependency values 234 and one or more pairwise coupling values 236. The dependency values 234 may include one or more correlation values, covariance-related values, lagged dependency values, sector-linkage values, factor-adjusted dependency values, or other inter-asset relational quantities. The pairwise coupling values 236 may include realized-volatility combinations, covariance-derived quantities, implied-volatility combinations, liquidity-weighted quantities, spread-derived quantities, or other non-negative pairwise quantities. In one embodiment, a network edge value may be computed in plain-text form as S_ij(t)=Corr(i,j,t)*F_cov(V_ij(t)). In certain embodiments, the network outputs 232 may include an adjacency matrix, weighted edge set, contagion metric, graph density metric, centrality metric, clustering metric, or regime-related graph measure.

In the predictive analytics step 240, the method 200 includes generating one or more predictive outputs 242 associated with one or more target market variables. In one embodiment, the predictive analytics step 240 includes computing one or more raw derivative quantities 244 and one or more recognition-scaled derivative quantities 246. In one embodiment, a raw first derivative is computed in plain-text form as dP_raw/dt=(P(t)−P(t−Delta t))/Delta t, and a recognition-scaled first derivative is computed in plain-text form as dP_rec/dt=dP_raw/dt*F_cov(Vol(t)). In another embodiment, a raw second derivative is computed in plain-text form as d2P_raw/dt2=(P(t)−2P(t−Delta t)+P(t−2Delta t))/(Delta t)\hat{ }2, and a recognition-scaled second derivative is computed in plain-text form as d2P_rec/dt2=d2P_raw/dt2*F_cov(Liq(t)). In one embodiment, a predictive output 242 may be generated in plain-text form as P_pred(t+Delta t)=P(t)+dP_rec/dt*Delta t+0.5*d2P_rec/dt2*(Delta t)\hat{ }2. In certain embodiments, the predictive outputs 242 may include price forecasts, return forecasts, direction forecasts, spread forecasts, yield forecasts, volatility forecasts, ranking outputs, or multi-horizon forecast outputs.

In the sentiment integration step 250, the method 200 includes generating one or more sentiment outputs 252 from one or more sentiment-bearing inputs. In one embodiment, the sentiment integration step 250 includes computing one or more raw sentiment values 254 from textual, social, event-based, or analyst-derived sources and applying one or more recognition-based transformations 256 to such raw sentiment values. In one embodiment, a bounded sentiment output may be computed in plain-text form as S_market(t)=F_cov(SentimentScore(t)). In certain embodiments, signed sentiment values are handled by applying a sign-preserving magnitude transform. In one embodiment, a signed sentiment value may be computed in plain-text form as S_signed(t)=sign(S_raw(t))*abs(S_raw(t))/(abs(S_raw(t))+X_opt). In certain embodiments, the sentiment outputs 252 may be used as stand-alone decision-support signals or in combination with one or more outputs from the network generation step 230, the predictive analytics step 240, the risk quantification step 260, or the portfolio allocation step 270.

In the risk quantification step 260, the method 200 includes generating one or more risk outputs 262 based on one or more risk-related inputs 264. In various embodiments, the risk-related inputs 264 may include realized volatility values, implied volatility values, drawdown values, liquidity stress values, contagion-related values, spread-widening values, jump-related values, or other market-stress indicators. In one embodiment, the risk quantification step 260 includes computing one or more recognition-transformed risk values 266 using the recognition coverage function. In one embodiment, a risk output 262 may be computed in plain-text form as R(t)=F_cov(Vol(t)). In certain embodiments, the risk outputs 262 may be used to trigger alerts, modify forecast confidence, adjust exposure, apply hedge logic, enforce risk thresholds, or influence one or more downstream portfolio allocation decisions.

In the portfolio allocation step 270, the method 200 includes generating one or more allocation outputs 272 for one or more assets or instruments. In one embodiment, the portfolio allocation step 270 includes receiving one or more asset-evaluation values 274 and computing one or more intermediate recognition-adjusted weight values 276. In one embodiment, an intermediate weight value may be computed in plain-text form as w_i=w0_i*F_cov(Q_i), where w0_i is a base weight and Q_i is a selected quality or evaluation metric associated with asset i. In certain embodiments, the asset-evaluation values 274 may include Sharpe ratios, risk-adjusted return values, confidence-weighted forecast values, sentiment-weighted values, momentum-related values, or combinations thereof. In certain embodiments, the intermediate recognition-adjusted weight values 276 are normalized to generate final allocation outputs 272.

In certain implementations, the portfolio allocation step 270 may be performed in a long-only mode, a long-short mode, a leverage-constrained mode, a risk-budgeted mode, a sector-constrained mode, or a liquidity-constrained mode. In one long-only embodiment, negative quality values may be clipped, floored, offset, or otherwise handled before recognition-based transformation. In one long-short embodiment, the sign of an input quality value is preserved and the magnitude of the input quality value is recognition-scaled before normalization or exposure capping.

In the output generation step 280, the method 200 includes generating one or more system outputs 282 based on one or more upstream outputs. In certain embodiments, the output generation step 280 receives one or more network outputs 232, one or more predictive outputs 242, one or more sentiment outputs 252, one or more risk outputs 262, and one or more allocation outputs 272, and generates one or more forecast values, directional indicators, confidence values, alert messages, rankings, hedge recommendations, rebalance recommendations, watchlist outputs, reports, dashboards, transmitted messages, or execution-related outputs. In certain embodiments, the output generation step 280 includes a combination or fusion operation in which two or more subsystem outputs are aggregated using one or more weighting, voting, ranking, confidence, or rule-based mechanisms.

In one embodiment, a combined forecast or combined output may be generated using weighted subsystem values. For example, a combined output may be computed in plain-text form as Y_pred(t+Delta t)=alpha*P_pred(t+Delta t)+beta*S_market(t)+gamma*sum_j S_ij(t), where alpha, beta, and gamma are weighting values associated with one or more subsystem outputs. In certain embodiments, the weighting values may be fixed, adaptive, confidence-based, user-defined, system-defined, derived from recent performance, or omitted in favor of a non-scalar multi-component output representation.

In certain embodiments, the method 200 further includes generating a confidence value 284 associated with one or more outputs. In one embodiment, the confidence value 284 is determined based on agreement among a plurality of subsystem outputs. In one embodiment, a confidence value may be computed in plain-text form as C(t)=F_cov(N_concordant/N_total), where N_concordant is a number of subsystem outputs, features, nodes, or signals satisfying a selected agreement condition and N_total is a total number of considered subsystem outputs, features, nodes, or signals. In certain embodiments, the confidence value 284 may be used to rank outputs, suppress low-confidence recommendations, alter threshold logic, scale exposure, or prioritize alerts.

In certain embodiments, the method 200 further includes regime detection or contagion detection 286. In one embodiment, regime detection or contagion detection 286 is performed by monitoring one or more graph-related values, volatility-related values, dependency-related values, sentiment-related values, or confidence-related values over time. In certain embodiments, a regime change may be identified when one or more graph density values, centrality values, edge distributions, volatility indicators, or cross-asset coupling indicators satisfy one or more selected conditions. In certain embodiments, a detected regime condition may be used to modify one or more subsequent operations of the method 200, including forecast generation, risk thresholding, output routing, or allocation logic.

Although FIG. 2 illustrates one exemplary sequence of steps, the disclosed subject matter is not limited to the exact order shown. In various embodiments, the network generation step 230, predictive analytics step 240, sentiment integration step 250, risk quantification step 260, and portfolio allocation step 270 may be executed serially, in parallel, iteratively, or in partially overlapping fashion. One or more steps may be performed on demand, continuously, according to a schedule, in response to one or more triggers, or based on one or more event conditions. In certain embodiments, one or more intermediate results may be cached, stored, reused, streamed, or transmitted to other services or processes.

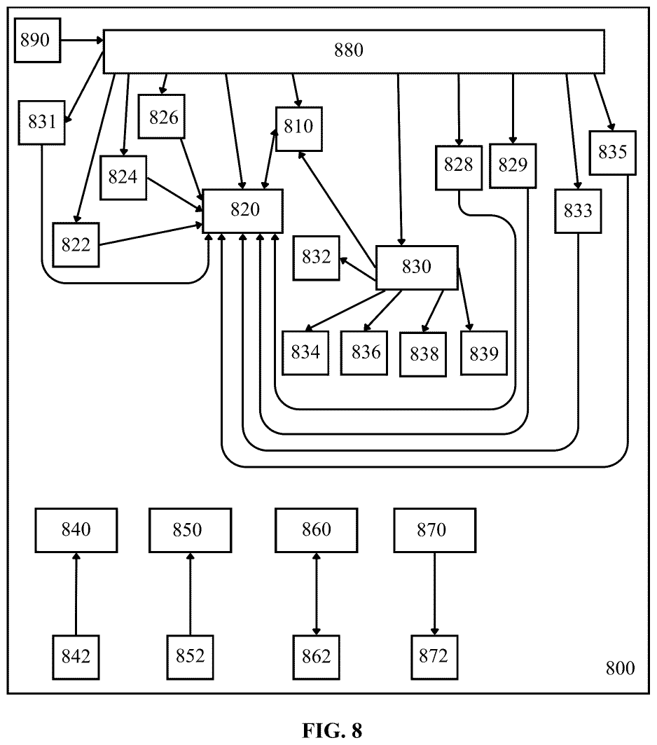

In certain embodiments, one or more steps of the method 200 are performed by the financial market prediction system 100 of FIG. 1, the computing environment 800 of FIG. 8, or another suitable computing platform. In certain embodiments, one or more steps of the method 200 are embodied in instructions stored on a non-transitory computer-readable medium and executed by one or more processors. In certain embodiments, one or more steps of the method 200 are implemented using software, hardware, firmware, or combinations thereof.

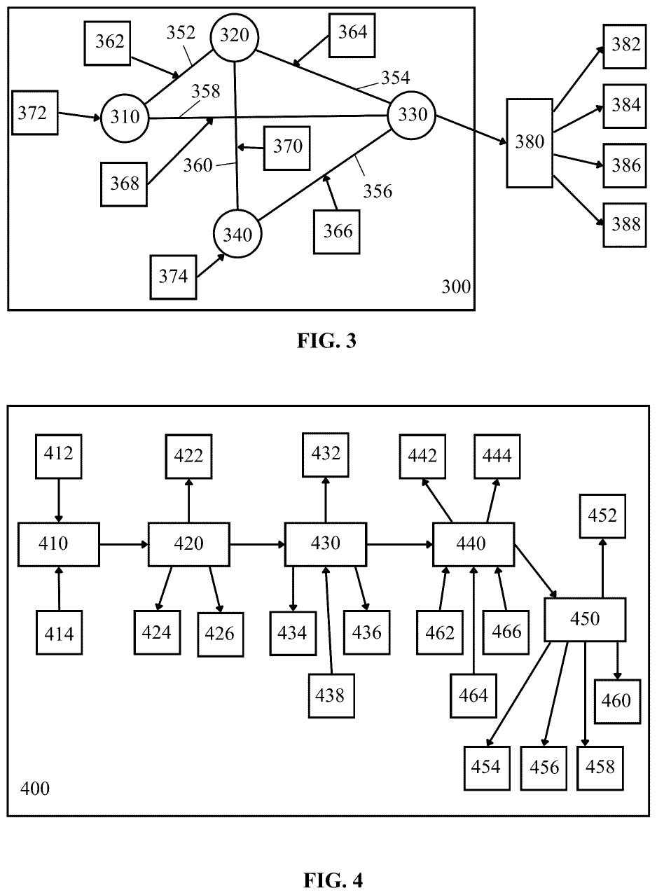

FIG. 3 illustrates an exemplary recognition-based financial network 300 configured to represent structural relationships among a plurality of financial instruments using recognition-transformed edge values. In the illustrated embodiment, the recognition-based financial network 300 includes a first asset node 310, a second asset node 320, a third asset node 330, a fourth asset node 340, and a set of weighted edges extending between selected pairs of asset nodes. Although four asset nodes are shown for ease of illustration, the recognition-based financial network 300 may include any suitable number of nodes corresponding to financial instruments, baskets, sectors, indices, contracts, or other market entities.

In one embodiment, each of the asset nodes 310, 320, 330, and 340 represents a respective financial instrument or market entity for which one or more market-observable or derived values are available. For example, an asset node may correspond to an equity, exchange-traded fund, index constituent, futures contract, option-related underlying, currency pair, commodity instrument, fixed-income instrument, digital asset, or another selected financial entity. In certain embodiments, the recognition-based financial network 300 may include nodes associated with sectors, industries, macro factors, geographic regions, volatility surfaces, baskets, portfolios, or synthetic groupings rather than individual instruments alone.

In the illustrated embodiment, a first edge 352 extends between the first asset node 310 and the second asset node 320, a second edge 354 extends between the second asset node 320 and the third asset node 330, a third edge 356 extends between the third asset node 330 and the fourth asset node 340, a fourth edge 358 extends between the first asset node 310 and the third asset node 330, and a fifth edge 360 extends between the second asset node 320 and the fourth asset node 340. In certain embodiments, fewer edges, additional edges, directional edges, signed edges, filtered edges, thresholded edges, or dynamically changing edges may be used. In certain embodiments, the edges of the recognition-based financial network 300 may be represented as entries of an adjacency matrix, a sparse edge list, a graph object, a tensor, or another data structure.

In certain embodiments, the recognition-based financial network 300 is stored, updated, transmitted, or otherwise processed as a network data structure, including for example an adjacency matrix, a sparse edge list, a graph object, a tensor representation, or another machine-usable graph representation.

In certain embodiments, the network data structure is persisted in memory as a machine-usable representation that supports update, thresholding, filtering, traversal, centrality computation, clustering computation, contagion computation, or downstream subsystem access. In certain embodiments, the network data structure includes weighted edge entries, node identifiers, timestamps, horizon identifiers, threshold metadata, or cached graph metrics.

In certain embodiments, the network data structure is updated incrementally as new market data arrives, such that only affected edge values, node values, or graph metrics are recomputed. In certain other embodiments, the network data structure is recomputed for a rolling window, an event-triggered window, or a selected batch interval.

In certain embodiments, multiple network data structures are maintained concurrently for different time horizons, market segments, asset classes, or dependency definitions, and one or more downstream subsystems selectively access a first network data structure for a first processing task and a second network data structure for a second processing task.

In one embodiment, each edge between a selected pair of asset nodes is determined using a dependency value and a recognition-transformed coupling value. In one embodiment, an edge value between asset i and asset j at time t is computed in plain-text form as S_ij(t)=Corr(i,j,t)*F_cov(V_ij(t)), where Corr(i,j,t) is a selected dependency measure between asset i and asset j, V_ij(t) is a non-negative pairwise coupling quantity associated with asset i and asset j, and F_cov is a recognition coverage function. In one embodiment, the recognition coverage function is defined in plain-text form as F_cov(r)=r/(r+X_opt), where r is a non-negative input quantity and X_opt is a positive scale constant. In certain preferred embodiments, X_opt=phi/pi.

In certain embodiments, the dependency measure Corr(i,j,t) may be based on a Pearson correlation, Spearman correlation, Kendall correlation, covariance-derived dependency, lagged dependency, factor-adjusted dependency, partial correlation, coherence measure, mutual-information-derived measure, transfer-entropy-related value, or another selected inter-asset relational quantity. In certain embodiments, the pairwise coupling quantity V_ij(t) may be based on a realized volatility combination, an implied volatility combination, a covariance magnitude, a liquidity-related value, a spread-related value, a stress-related quantity, or another non-negative quantity associated with the relationship between asset i and asset j.

In one embodiment, the pairwise coupling quantity V_ij(t) may be computed in plain-text form as V_ij(t)=sqrt (Vol_i(t)\hat{ }2+Vol_j(t)\hat{ }2), where Vol_i(t) and Vol_j(t) are selected volatility-related values for asset i and asset j, respectively. In another embodiment, the pairwise coupling quantity V_ij(t) may be computed using a weighted average, covariance-derived magnitude, stress-adjusted quantity, liquidity-adjusted quantity, or another selected aggregation of one or more asset-specific or pair-specific inputs. The disclosed subject matter is not limited to any single formula for V_ij(t), provided that the resulting quantity is suitable for use in the recognition-based transformation. In certain embodiments, the first edge 352 may represent a first recognition-weighted inter-asset relationship 362, the second edge 354 may represent a second recognition-weighted inter-asset relationship 364, the third edge 356 may represent a third recognition-weighted inter-asset relationship 366, the fourth edge 358 may represent a fourth recognition-weighted inter-asset relationship 368, and the fifth edge 360 may represent a fifth recognition-weighted inter-asset relationship 370. Each recognition-weighted inter-asset relationship may be positive, negative, near zero, or dynamically varying over time depending on the selected dependency measure, the selected coupling quantity, and the resulting transformed value.

In one embodiment, the recognition-based financial network 300 is generated from one or more dependency inputs 372 and one or more coupling inputs 374. The one or more dependency inputs 372 may include rolling correlations, lagged influence scores, covariance terms, sector co-movement values, factor-exposure similarity values, or other measures of inter-asset dependence. The one or more coupling inputs 374 may include volatility values, liquidity-derived values, drawdown-related values, stress-related values, spread-related values, or combinations thereof. In certain embodiments, the one or more dependency inputs 372 and the one or more coupling inputs 374 are computed from the prepared market variables 122 generated by the preprocessing subsystem 120 of FIG. 1. In certain embodiments, the recognition-based financial network 300 further generates one or more network outputs 380. In the illustrated embodiment, the one or more network outputs 380 may include a graph density output 382, a centrality output 384, a clustering output 386, and a contagion output 388. The graph density output 382 may indicate a level of overall connectivity or significant coupling among a selected set of asset nodes. The centrality output 384 may indicate the relative importance, influence, or connectivity of one or more nodes within the recognition-based financial network 300. The clustering output 386 may indicate one or more communities, sectors, or substructures within the recognition-based financial network 300. The contagion output 388 may indicate a degree to which stress, volatility, directional change, or dependency behavior is propagating through the recognition-based financial network 300.

In one embodiment, a graph density value may be computed in plain-text form as D_graph(t)=count (abs(S_ij(t))>tau)/M, where tau is a selected threshold and M is the number of possible edges in a selected graph representation. In certain embodiments, the threshold tau may be fixed, adaptive, percentile-based, regime-based, or otherwise selected. In certain embodiments, the graph density value may be monitored over time to identify regime transitions, elevated connectivity conditions, sector rotations, or contagion-related events.

Dependency estimation window. In one embodiment, Corr(i,j,t) is computed over a rolling window W_corr between 20 and 500 samples.

Network threshold. In one embodiment, τ is between 0.05 and 0.50 for abs(S_ij(t)) thresholding, and edges below t are omitted from a sparse edge list.

Modifier cadence. In one embodiment, the volatility-related modifier input is updated at least as often as Delta T, and the liquidity-related modifier input is updated at least once per K samples, where K is between 1 and 50.

In certain embodiments, one or more centrality values may be computed for each of the asset nodes 310, 320, 330, and 340. For example, degree centrality, weighted degree centrality, eigenvector centrality, closeness centrality, betweenness centrality, PageRank-type centrality, or another selected node-importance measure may be computed. In certain embodiments, centrality values may be used to identify systemically important instruments, stress-propagation candidates, hedge anchors, or monitoring priorities.

In certain embodiments, the recognition-based financial network 300 may be updated continuously, periodically, event-driven, or on demand. For example, one or more of the edges of the recognition-based financial network 300 may be recomputed using rolling-window dependency estimates, event-triggered dependency estimates, intraday dependency estimates, end-of-day dependency estimates, or multi-horizon dependency estimates. In certain embodiments, a first version of the recognition-based financial network 300 may be associated with a first time horizon and a second version of the recognition-based financial network 300 may be associated with a second time horizon.

In certain embodiments, the recognition-based financial network 300 may be undirected, directed, signed, unsigned, sparse, dense, thresholded, layered, multiplexed, or otherwise structured according to implementation choice. In one directed embodiment, a directional edge may reflect a lagged influence measure or information-transfer measure from one asset node to another asset node. In one signed embodiment, positive and negative dependencies may be retained as signed edge values, whereas in another embodiment absolute magnitudes may be used for selected downstream computations. In one sparse embodiment, edges below a selected threshold magnitude are omitted, compressed, or zeroed.

In certain embodiments, the recognition-based financial network 300 is used to support one or more downstream operations of the financial market prediction system 100. For example, one or more network outputs 380 may be provided to the recognition-informed predictive analytics subsystem 140, the recognition-based risk quantification subsystem 160, the recognition-based portfolio allocation subsystem 170, or the output generation subsystem 180. In certain embodiments, a change in one or more network outputs 380 may cause the system to alter forecast weighting, risk thresholds, portfolio allocation logic, alert behavior, or execution-related recommendations.

In certain embodiments, the recognition-based financial network 300 provides a technical improvement by representing inter-asset relationships using a bounded recognition-transformed coupling component rather than relying solely on raw dependency magnitudes. In certain implementations, this can reduce sensitivity to unstable raw magnitude changes, support bounded edge scaling, and enable consistent use of cross-asset structure in forecasting, risk management, regime detection, and portfolio allocation.

Although FIG. 3 illustrates a compact example with four asset nodes and five weighted edges, the disclosed subject matter is not limited to that arrangement. The recognition-based financial network 300 may include hundreds, thousands, or more asset nodes and corresponding weighted edges, and may be implemented using one or more matrices, sparse representations, graph databases, streaming graph pipelines, hardware accelerators, or distributed compute resources.

In one illustrative example, a first asset and a second asset may have a dependency value Corr(i,j,t)=0.62 and a pairwise coupling quantity V_ij(t)=0.80. Using X_opt=0.515 as an approximation of phi/pi, the recognition coverage value may be computed as F_cov(0.80)=0.80/(0.80+0.515) approx. 0.608. The corresponding network edge value may then be computed as S_ij(t)=0.62×0.608 approx. 0.377. In certain embodiments, the resulting edge value is stored in the network data structure and used in one or more downstream graph computations.

FIG. 4 illustrates an exemplary recognition-informed predictive analytics process 400 configured to generate one or more forecast outputs for one or more target market variables using one or more recognition-scaled derivative quantities. In the illustrated embodiment, the recognition-informed predictive analytics process 400 includes a target-variable input stage 410, a derivative computation stage 420, a recognition-scaling stage 430, a forecast generation stage 440, and a predictive output stage 450.

In the target-variable input stage 410, the recognition-informed predictive analytics process 400 receives one or more target-variable inputs 412 and one or more modifier inputs 414. The one or more target-variable inputs 412 may include, for example, price values, return values, spread values, yield values, index values, basket values, volatility-related values, or other selected market variables associated with one or more financial instruments or groups of financial instruments. The one or more modifier inputs 414 may include volatility values, liquidity values, stress-related values, event-related values, confidence-related values, or other quantities used to recognition-scale one or more derivative or forecast components.

In one embodiment, the target-variable input stage 410 receives a time-ordered sequence of target values P(t), P(t−Delta t), and P(t−2Delta t), where P(t) represents a current observed value of a target market variable, P(t−Delta t) represents a prior observed value, and P(t−2Delta t) represents an earlier observed value. In certain embodiments, the spacing Delta t may correspond to a tick interval, sub-second interval, minute interval, hourly interval, daily interval, weekly interval, event-driven interval, or another selected sampling interval.

In the derivative computation stage 420, the recognition-informed predictive analytics process 400 computes one or more raw derivative quantities 422 from the one or more target-variable inputs 412. In one embodiment, the one or more raw derivative quantities 422 include a raw first derivative 424 and a raw second derivative 426. In one embodiment, the raw first derivative 424 is computed in plain-text form as dP_raw/dt=(P(t)−P(t−Delta t))/Delta t. In one embodiment, the raw second derivative 426 is computed in plain-text form as d2P_raw/dt2=(P(t)−2P(t−Delta t)+P(t−2Delta t))/(Delta t)\hat{ }2.

In certain embodiments, the derivative computation stage 420 may compute additional or alternative derivative-related quantities. For example, the derivative computation stage 420 may compute one or more higher-order derivatives, finite differences, smoothed derivatives, trend terms, acceleration terms, jerk terms, slope estimates, curvature estimates, rolling momentum values, or state-transition values. In certain embodiments, the derivative computation stage 420 may include denoising, smoothing, clipping, filtering, interpolation, or window-based aggregation to reduce sensitivity to noise or missing observations.

In the recognition-scaling stage 430, the recognition-informed predictive analytics process 400 computes one or more recognition-scaled derivative quantities 432 using the one or more modifier inputs 414. In one embodiment, the one or more recognition-scaled derivative quantities 432 include a recognition-scaled first derivative 434 and a recognition-scaled second derivative 436. In one embodiment, the recognition-scaled first derivative 434 is computed in plain-text form as dP_rec/dt=dP_raw/dt*F_cov(Vol(t)), where Vol(t) is a selected volatility-related modifier input. In one embodiment, the recognition-scaled second derivative 436 is computed in plain-text form as d2P_rec/dt2=d2P_raw/dt2*F_cov(Liq(t)), where Liq(t) is a selected liquidity-related modifier input.

In one embodiment, the recognition-scaling stage 430 applies a recognition coverage function 438 to one or more non-negative modifier inputs. In one embodiment, the recognition coverage function 438 is defined in plain-text form as F_cov(r)=r/(r+X_opt), where r is a non-negative input quantity and X_opt is a positive scale constant. In certain preferred embodiments, X_opt=phi/pi. In certain embodiments, the modifier inputs processed by the recognition coverage function 438 may include realized volatility values, implied volatility values, liquidity-related values, spread-related values, event-intensity values, drawdown-related values, stress metrics, or other quantities selected to regulate the influence of one or more derivative terms.

In certain embodiments, one or more raw modifier inputs are converted to one or more recognition-compatible modifier values before application of the recognition coverage function 438. For example, a raw liquidity measure, spread measure, stress measure, or event score may be scaled, clipped, normalized, smoothed, shifted, or otherwise transformed to form a non-negative modifier input suitable for use in the recognition-scaling stage 430. In one embodiment, a modifier value r_mod may be expressed in plain-text form as r_mod=h_mod(x_mod), where h_mod is a preprocessing function applied to a raw modifier value x_mod.

In the forecast generation stage 440, the recognition-informed predictive analytics process 400 computes one or more forecast values 442 from the one or more recognition-scaled derivative quantities 432. In one embodiment, the one or more forecast values 442 include a next-horizon forecast 444. In one embodiment, the next-horizon forecast 444 is computed in plain-text form as P_pred(t+Delta t)=P(t)+dP_rec/dt*Delta t+0.5*d2P_rec/dt2*(Delta t)\hat{ }2. In certain embodiments, the next-horizon forecast 444 is generated for a future price value, return value, spread value, yield value, volatility value, or other selected target variable.

In certain embodiments, the forecast generation stage 440 may omit the second-order term, include one or more higher-order terms, include one or more event-response terms, include one or more graph-conditioned terms, or otherwise modify the predictive form used. In one embodiment, a first-order forecast may be expressed in plain-text form as P_pred(t+Delta t)=P(t)+dP_rec/dt*Delta t. In another embodiment, one or more higher-order or auxiliary terms may be added to capture curvature, stress, correlation structure, or exogenous event effects.

In certain embodiments, the forecast generation stage 440 may generate multi-horizon forecasts. For example, a first forecast may be generated for a first horizon Delta t_1, a second forecast may be generated for a second horizon Delta t_2, and a third forecast may be generated for a third horizon Delta t_3. In certain embodiments, multi-horizon outputs may be stored separately, ranked, fused, confidence-scored, or used in downstream allocation or alert logic.

In the predictive output stage 450, the recognition-informed predictive analytics process 400 generates one or more predictive outputs 452. In the illustrated embodiment, the one or more predictive outputs 452 may include a forecasted value output 454, a directional output 456, a magnitude output 458, and a forecast-confidence-related output 460. The forecasted value output 454 may correspond to a predicted future value of a target variable. The directional output 456 may indicate an expected upward movement, downward movement, widening movement, narrowing movement, or other directional change. The magnitude output 458 may represent an absolute or relative forecast size. The forecast-confidence-related output 460 may represent a confidence score, ranking value, threshold state, or other quality indicator associated with the forecast.

In certain embodiments, the recognition-informed predictive analytics process 400 further receives one or more graph-related inputs 462 from the recognition-based financial network subsystem 130, one or more sentiment-related inputs 464 from the recognition-based sentiment integration subsystem 150, or one or more risk-related inputs 466 from the recognition-based risk quantification subsystem 160. In certain embodiments, the one or more graph-related inputs 462, one or more sentiment-related inputs 464, or one or more risk-related inputs 466 may be used to gate, weight, suppress, amplify, or otherwise alter one or more forecast values 442 or predictive outputs 452.

In one embodiment, the recognition-informed predictive analytics process 400 provides a technical improvement by applying a bounded recognition-based scaling operation to one or more derivative-related quantities rather than relying solely on raw derivative extrapolation. In certain implementations, this can reduce sensitivity to extreme or unstable input magnitudes, improve numerical behavior under volatile conditions, and provide a computationally efficient closed-form forecast structure suitable for repeated machine implementation.

In certain embodiments, the predictive output is generated by processor-executed operations that retrieve target-variable values and modifier inputs from memory, compute the first derivative quantity and the second derivative quantity, compute the transformed first-derivative modifier and the transformed second-derivative modifier, generate the predictive output, and store or route the predictive output to one or more downstream components. In certain embodiments, the predictive output is stored in memory, transmitted through an interface, written to a data structure, associated with a timestamp, or provided to an output engine for further processing.

In certain embodiments, one or more predictive outputs are generated for a plurality of instruments in a vectorized, batched, or streaming manner. In certain implementations, the disclosed architecture supports repeated machine execution over rolling windows or live data feeds while maintaining a bounded modifier application at one or more derivative-processing stages.

In certain embodiments, if one or more modifier inputs fail a quality condition, fall outside a selected operating range, or are unavailable for a selected interval, the system may suppress a predictive output, substitute a fallback modifier value, reduce confidence, or tag the predictive output with a degraded-quality state.

In certain embodiments, the recognition-informed predictive analytics process 400 may be executed continuously, periodically, on demand, upon occurrence of one or more market events, or in response to one or more trigger conditions. In certain embodiments, one or more intermediate values produced in the derivative computation stage 420, the recognition-scaling stage 430, or the forecast generation stage 440 may be stored, cached, logged, streamed, or reused by other subsystems of the financial market prediction system 100.

Although FIG. 4 illustrates one exemplary recognition-informed predictive analytics process 400, the disclosed subject matter is not limited to the exact arrangement shown. One or more stages may be combined, omitted, reordered, repeated, or supplemented with additional functionality. One or more computations may be performed using scalar, vector, matrix, tensor, batched, or streaming operations. The target variable may correspond to any suitable market-related quantity, and the modifier inputs may comprise any suitable recognition-compatible quantities selected to regulate one or more forecast terms.

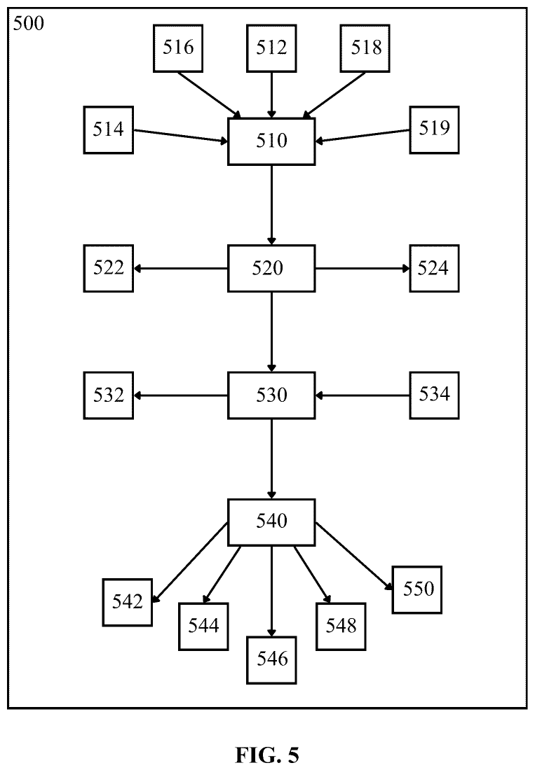

FIG. 5 illustrates an exemplary recognition-based sentiment integration process 500 configured to generate one or more bounded sentiment outputs from one or more sentiment-bearing inputs. In the illustrated embodiment, the recognition-based sentiment integration process 500 includes a sentiment-input stage 510, a sentiment-evaluation stage 520, a recognition-transformation stage 530, and a sentiment-output stage 540.

In the sentiment-input stage 510, the recognition-based sentiment integration process 500 receives one or more sentiment-bearing inputs 512. In various embodiments, the one or more sentiment-bearing inputs 512 may include news-derived inputs 514, social-media-derived inputs 516, analyst-derived inputs 518, and event-derived inputs 519. The news-derived inputs 514 may include financial headlines, articles, wire reports, company announcements, regulatory disclosures, or macroeconomic reports. The social-media-derived inputs 516 may include messages, posts, feeds, trend measures, topic velocity measures, or entity-linked social signals. The analyst-derived inputs 518 may include commentary, upgrades, downgrades, target revisions, or structured opinion signals. The event-derived inputs 519 may include earnings-call information, corporate-event information, macroeconomic release information, litigation-related information, geopolitical event information, or other event-associated data.

In certain embodiments, the one or more sentiment-bearing inputs 512 are first filtered, aligned, tagged, ranked, or normalized before further processing. For example, the recognition-based sentiment integration process 500 may associate one or more text items or event items with a selected asset, sector, basket, index, macro regime, or market state. In certain embodiments, one or more source-credibility indicators, recency indicators, entity-confidence indicators, topic scores, or event-severity indicators may also be associated with the one or more sentiment-bearing inputs 512. In the sentiment-evaluation stage 520, the recognition-based sentiment integration process 500 computes one or more raw sentiment values 522 from the one or more sentiment-bearing inputs 512. In certain embodiments, the one or more raw sentiment values 522 may include a positive sentiment component, a negative sentiment component, a net sentiment value, a source-weighted sentiment value, an event-linked sentiment value, or a momentum-of-sentiment value. In one embodiment, the one or more raw sentiment values 522 may be generated using scoring logic, lexicon logic, classifier logic, embedding-based logic, model-based logic, event-tagging logic, or combinations thereof.

In certain embodiments, the sentiment-evaluation stage 520 further computes one or more aggregated sentiment values 524. For example, the recognition-based sentiment integration process 500 may aggregate sentiment values across multiple documents, multiple posts, multiple sources, multiple events, or multiple entities to generate an asset-level sentiment value, a sector-level sentiment value, a market-wide sentiment value, or a time-window-specific sentiment value. In one embodiment, an aggregated raw sentiment value may be represented in plain-text form as S_raw(t)=sum_m omega_m*s_m(t), where s_m(t) represents a sentiment contribution from source or item m and omega_m represents a corresponding weighting value.

In the recognition-transformation stage 530, the recognition-based sentiment integration process 500 computes one or more recognition-transformed sentiment values 532. In one embodiment, the recognition-transformation stage 530 applies a recognition coverage function 534 to a non-negative sentiment magnitude or sentiment score. In one embodiment, a bounded sentiment value may be computed in plain-text form as S_market(t)=F_cov(SentimentScore(t)), where F_cov(r)=r/(r+X_opt). In certain preferred embodiments, X_opt=phi/pi.

In certain embodiments, the recognition-transformation stage 530 handles signed sentiment values using a sign-preserving magnitude transformation. In one embodiment, a signed bounded sentiment value may be computed in plain-text form as S_signed(t)=sign(S_raw(t))*abs(S_raw(t))/(abs(S_raw(t))+X_opt). In certain embodiments, this signed embodiment is useful where the direction of sentiment, and not merely its magnitude, is relevant to one or more downstream outputs.

In certain embodiments, one or more raw sentiment values are first converted into one or more recognition-compatible sentiment values before application of the recognition coverage function 534. For example, a raw sentiment magnitude may be clipped, scaled, normalized, confidence-weighted, source-weighted, recency-weighted, or transformed using another selected preprocessing function. In one embodiment, a transformed sentiment value r_sent may be represented in plain-text form as r_sent=h_sent (S_input), where h_sent is a preprocessing function applied to a raw sentiment-related input S_input.

In the sentiment-output stage 540, the recognition-based sentiment integration process 500 generates one or more sentiment outputs 542. In the illustrated embodiment, the one or more sentiment outputs 542 may include an asset sentiment output 544, a sector sentiment output 546, a market sentiment output 548, and a sentiment-confidence output 550. The asset sentiment output 544 may correspond to one or more individual instruments or issuers. The sector sentiment output 546 may correspond to one or more groups of related assets. The market sentiment output 548 may correspond to an aggregate market-level or regime-level sentiment signal. The sentiment-confidence output 550 may correspond to a confidence value, source-agreement value, recency-weighted reliability value, or another quality-related measure associated with one or more sentiment outputs.

In certain embodiments, one or more sentiment outputs 542 are provided to the recognition-informed predictive analytics process 400 of FIG. 4, the recognition-based risk quantification subsystem 160 of FIG. 1, the recognition-based portfolio allocation subsystem 170 of FIG. 1, or the output generation subsystem 180 of FIG. 1. In certain embodiments, one or more sentiment outputs 542 may be used to modify a forecast value, alter a risk threshold, affect an alert condition, adjust an allocation weight, or contribute to a combined market output.

In certain embodiments, the recognition-based sentiment integration process 500 provides a technical improvement by transforming one or more sentiment-related inputs into bounded outputs that can be more consistently integrated with price-based, network-based, and risk-based quantities. In certain implementations, this can reduce instability associated with unbounded or poorly normalized sentiment magnitudes and can support unified downstream processing within the financial market prediction system 100.

Although FIG. 5 illustrates one exemplary recognition-based sentiment integration process 500, the disclosed subject matter is not limited to the exact arrangement shown. One or more stages may be omitted, reordered, repeated, or supplemented. One or more sentiment-bearing inputs may be textual, numeric, categorical, event-based, or hybrid. One or more outputs may be asset-specific, sector-specific, market-wide, horizon-specific, or event-specific generate one or more bounded risk outputs from one or more risk-related inputs. In the illustrated embodiment, the recognition-based risk quantification process 600 includes a risk-input stage 610, a risk-evaluation stage 620, a recognition-transformation stage 630, and a risk-output stage 640.

In the risk-input stage 610, the recognition-based risk quantification process 600 receives one or more risk-related inputs 612. In various embodiments, the one or more risk-related inputs 612 may include volatility-related inputs 614, liquidity-related inputs 616, drawdown-related inputs 618, contagion-related inputs 619, and spread- or stress-related inputs 622. The volatility-related inputs 614 may include realized volatility values, implied volatility values, historical volatility values, forward-looking volatility estimates, or volatility-of-volatility values. The liquidity-related inputs 616 may include bid-ask spread measures, order-book depth measures, slippage measures, turnover measures, or market-impact-related values. The drawdown-related inputs 618 may include peak-to-trough decline measures, rolling loss measures, downside deviation values, or stress-window loss values. The contagion-related inputs 619 may include graph-based spillover measures, dependency-amplification measures, centrality-linked stress values, or cross-asset propagation indicators. The spread- or stress-related inputs 622 may include credit spread values, basis dislocation values, jump indicators, gap indicators, or event-stress measures.

In certain embodiments, the one or more risk-related inputs 612 are first filtered, aligned, scaled, normalized, or otherwise prepared for downstream processing. For example, one or more raw risk-related values may be converted into non-negative recognition-compatible inputs by clipping, shifting, scaling, smoothing, percentile mapping, rolling normalization, or another selected preprocessing operation. In one embodiment, a recognition-compatible risk input may be represented in plain-text form as r_risk=h_risk(x_risk), where h_risk is a preprocessing function applied to a raw risk-related value x_risk.

In the risk-evaluation stage 620, the recognition-based risk quantification process 600 computes one or more raw risk values 624 from the one or more risk-related inputs 612. In certain embodiments, the one or more raw risk values 624 may include a volatility risk value 626, a liquidity stress value 628, a drawdown risk value 629, and a contagion risk value 632. In certain embodiments, the one or more raw risk values 624 may be computed independently for a single asset, for a portfolio, for a sector, for a basket, or for a broader market state.

In one embodiment, the volatility risk value 626 is based on one or more realized or implied volatility measures associated with a selected asset or group of assets. In one embodiment, the liquidity stress value 628 is based on one or more spread, impact, or depth measures. In one embodiment, the drawdown risk value 629 is based on a recent decline from a prior reference value. In one embodiment, the contagion risk value 632 is based on one or more outputs from the recognition-based financial network 300, including one or more graph density values, centrality values, edge-strength values, or coupling-amplification values.

In the recognition-transformation stage 630, the recognition-based risk quantification process 600 computes one or more recognition-transformed risk values 634. In one embodiment, the recognition-transformation stage 630 applies a recognition coverage function 636 to one or more non-negative risk-related inputs. In one embodiment, a risk output may be computed in plain-text form as R(t)=F_cov(Vol(t)), where Vol(t) is a selected volatility-related input and F_cov(r)=r/(r+X_opt). In certain preferred embodiments, X_opt=phi/pi.

In certain embodiments, the recognition-transformation stage 630 computes a plurality of transformed risk components and combines them to form a composite risk value. By way of example, a transformed volatility component, a transformed liquidity component, a transformed drawdown component, and a transformed contagion component may be aggregated using a selected weighting, ranking, or gating rule. In certain embodiments, one or more such components may be omitted, emphasized, or thresholded depending on the asset class, time horizon, or operational mode. In one embodiment, a transformed liquidity-related risk component may be represented in plain-text form as R_liq(t)=F_cov(LiqStress(t)), where LiqStress(t) is a selected liquidity-related quantity. In one embodiment, a transformed drawdown-related risk component may be represented in plain-text form as R_dd(t)=F_cov(Drawdown(t)), where Drawdown(t) is a selected non-negative drawdown quantity. In one embodiment, a transformed contagion-related risk component may be represented in plain-text form as R_cont(t)=F_cov(Contagion(t)), where Contagion(t) is a selected non-negative contagion quantity.

In certain embodiments, the recognition-transformation stage 630 may generate a bounded composite risk value 638 based on two or more transformed risk components. In one embodiment, the bounded composite risk value 638 may be represented in plain-text form as R_comp(t)=aR_vol(t)+bR_liq(t)+cR_dd(t)+dR_cont(t), where a, b, c, and d are selected weighting values. In certain embodiments, the weighting values may be fixed, adaptive, normalized, confidence-derived, or otherwise selected. In certain other embodiments, the recognition-based risk quantification process 600 may output the transformed components separately instead of or in addition to a composite value.

In the risk-output stage 640, the recognition-based risk quantification process 600 generates one or more risk outputs 642. In the illustrated embodiment, the one or more risk outputs 642 may include an asset risk output 644, a portfolio risk output 646, a contagion alert output 648, and a threshold or gating output 650. The asset risk output 644 may correspond to one or more bounded risk values for one or more selected assets. The portfolio risk output 646 may correspond to one or more bounded risk values for a portfolio, basket, or sector. The contagion alert output 648 may correspond to a warning, flag, event state, or escalation indicator associated with cross-asset propagation or elevated coupling. The threshold or gating output 650 may correspond to a binary state, tiered state, or severity state used to influence one or more downstream operations.

In certain embodiments, one or more risk outputs 642 are provided to the recognition-informed predictive analytics process 400 of FIG. 4, the recognition-based portfolio allocation subsystem 170 of FIG. 1, or the output generation subsystem 180 of FIG. 1. In certain embodiments, one or more risk outputs 642 may be used to suppress low-quality forecasts, reduce exposure, increase hedge coverage, change alert thresholds, alter routing behavior, or modify one or more portfolio allocations.

In certain embodiments, the recognition-based risk quantification process 600 provides a technical improvement by transforming one or more raw risk-driving magnitudes into bounded outputs that can be more stably used in machine-implemented forecasting and allocation systems. In certain implementations, this can reduce sensitivity to extreme raw values, improve comparability across heterogeneous risk sources, and support unified integration of volatility, liquidity, drawdown, and contagion effects within the financial market prediction system 100.

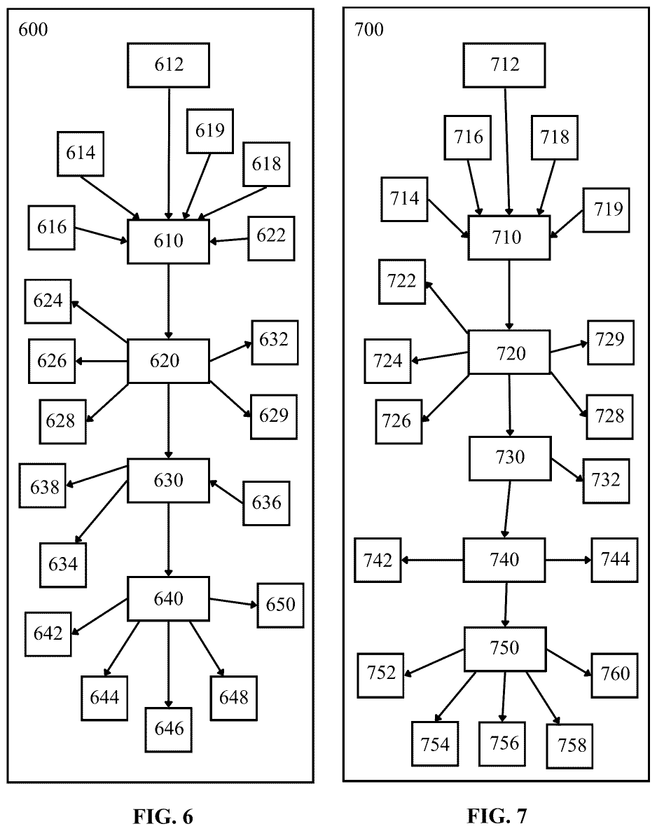

Although FIG. 6 illustrates one exemplary recognition-based risk quantification process 600, the disclosed subject matter is not limited to the exact arrangement shown. One or more stages may be omitted, reordered, repeated, or supplemented. One or more risk-related inputs 612 may be asset-specific, portfolio-specific, regime-specific, event-specific, or market-wide. One or more outputs may be continuous, discrete, thresholded, ranked, or multi-component.

In one illustrative example, if a selected volatility-related input is 1.10 and X_opt=0.515, a bounded risk output may be computed as R(t)=1.10/(1.10+0.515) approx. 0.681. In certain embodiments, the resulting risk value may be compared to one or more thresholds to trigger an alert, reduce forecast confidence, or reduce a proposed exposure.

FIG. 7 illustrates an exemplary recognition-based portfolio allocation process 700 configured to generate one or more adjusted allocation outputs for a plurality of assets, instruments, baskets, or portfolios using one or more recognition-transformed asset-evaluation quantities. In the illustrated embodiment, the recognition-based portfolio allocation process 700 includes an input stage 710, an asset-evaluation stage 720, a recognition-weighting stage 730, a normalization stage 740, and an allocation-output stage 750.

In the input stage 710, the recognition-based portfolio allocation process 700 receives one or more allocation-related inputs 712. In various embodiments, the one or more allocation-related inputs 712 may include base weight inputs 714, performance-related inputs 716, forecast-related inputs 718, and risk-related inputs 719. The base weight inputs 714 may include benchmark weights, equal weights, prior allocation weights, mandate-defined weights, sector weights, or user-defined starting weights. The performance-related inputs 716 may include Sharpe ratios, risk-adjusted return values, momentum-related values, return estimates, alpha-related values, or quality scores. The forecast-related inputs 718 may include one or more predictive outputs from the recognition-informed predictive analytics process 400, including one or more direction values, magnitude values, or confidence-related values. The risk-related inputs 719 may include one or more risk outputs from the recognition-based risk quantification process 600, including one or more volatility-related, liquidity-related, contagion-related, or threshold-related values.

In certain embodiments, the one or more allocation-related inputs 712 may further include one or more sentiment-related inputs from the recognition-based sentiment integration process 500 of FIG. 5 and one or more network-related inputs from the recognition-based financial network 300 of FIG. 3. In certain embodiments, the recognition-based portfolio allocation process 700 therefore uses a plurality of bounded or recognition-compatible inputs from multiple upstream subsystems in order to determine one or more adjusted allocation values.

In the asset-evaluation stage 720, the recognition-based portfolio allocation process 700 computes one or more asset-evaluation values 722 for one or more assets. In the illustrated embodiment, the one or more asset-evaluation values 722 may include a performance score 724, a forecast score 726, a risk-adjusted score 728, and a composite allocation score 729. In certain embodiments, the performance score 724 is based on a Sharpe ratio or another performance-related quantity. In certain embodiments, the forecast score 726 is based on one or more predictive outputs. In certain embodiments, the risk-adjusted score 728 incorporates one or more risk outputs. In certain embodiments, the composite allocation score 729 combines two or more such quantities using one or more selected weighting or selection rules.

In one embodiment, an asset-evaluation value for asset i is represented by Q_i. In certain embodiments, Q_i may correspond to a Sharpe ratio, a clipped Sharpe ratio, a forecast-confidence-weighted forecast value, a sentiment-adjusted score, a risk-adjusted score, or another selected asset-evaluation quantity. In certain embodiments, Q_i is non-negative. In certain other embodiments, Q_i may be signed, such as in a long-short implementation in which negative asset views are retained rather than clipped.

In the recognition-weighting stage 730, the recognition-based portfolio allocation process 700 computes one or more intermediate allocation values 732 using one or more recognition-transformed asset-evaluation values. In one embodiment, an intermediate allocation value 732 for asset i is computed in plain-text form as w_i=w0_i*F_cov(Q_i), where w0_i is a base weight associated with asset i and F_cov(Q_i) is a recognition-transformed version of the asset-evaluation value Q_i. In one embodiment, the recognition coverage function is defined in plain-text form as F_cov(r)=r/(r+X_opt), where r is a non-negative input quantity and X_opt is a positive scale constant. In certain preferred embodiments, X_opt=phi/pi.

In certain embodiments, the recognition-weighting stage 730 includes preprocessing one or more asset-evaluation values 722 before applying the recognition coverage function. For example, one or more raw Sharpe values, forecast values, confidence values, or composite values may be clipped, offset, scaled, normalized, smoothed, or otherwise transformed into one or more recognition-compatible values. In one embodiment, a transformed allocation input r_alloc may be represented in plain-text form as r_alloc=h_alloc (Q_raw), where h_alloc is a preprocessing function applied to a raw allocation-related quantity Q_raw.

In one long-only embodiment, negative asset-evaluation values are clipped or floored before recognition transformation. By way of example, a long-only performance quantity may be represented in plain-text form as Q_pos_i=max(Q_i, 0), after which an intermediate allocation value may be computed in plain-text form as w_i=w0_i*F_cov(Q_pos_i). In one long-short embodiment, the sign of an asset-evaluation value is preserved, and a sign-preserving recognition transformation is used. By way of example, a long-short intermediate value may be represented in plain-text form as w_i=sign(Q_i)*w0_i*abs(Q_i)/(abs(Q_i)+X_opt).

In the normalization stage 740, the recognition-based portfolio allocation process 700 computes one or more normalized allocation values 742 from the one or more intermediate allocation values 732. In one embodiment, the normalized allocation values 742 are produced by dividing each intermediate allocation value by a selected total magnitude. In one long-only embodiment, a final allocation value for asset i may be computed in plain-text form as W_i=w_i/sum_kw_k. In one long-short embodiment, a final allocation value for asset i may be computed in plain-text form as W_i=w_i/sum_k abs(w_k). In certain embodiments, the normalization stage 740 further applies one or more caps, floors, exposure limits, or balancing operations.

In certain embodiments, the normalization stage 740 applies one or more allocation constraints 744. The one or more allocation constraints 744 may include long-only constraints, leverage constraints, sector constraints, issuer constraints, liquidity constraints, turnover constraints, hedge constraints, beta constraints, duration constraints, or risk-budget constraints. In certain embodiments, one or more normalized allocation values 742 are adjusted to satisfy a selected set of operational, regulatory, liquidity, or portfolio-management conditions.

In the allocation-output stage 750, the recognition-based portfolio allocation process 700 generates one or more allocation outputs 752. In the illustrated embodiment, the one or more allocation outputs 752 may include an asset-weight output 754, a portfolio-weight output 756, a rebalance output 758, and an exposure-control output 760. The asset-weight output 754 may include one or more final weights for one or more individual assets or instruments. The portfolio-weight output 756 may include one or more aggregate portfolio-level exposure summaries. The rebalance output 758 may include one or more recommended changes to an existing portfolio. The exposure-control output 760 may include one or more weight caps, reductions, suppressions, or override actions based on one or more risk, confidence, or policy conditions.

In certain embodiments, one or more allocation outputs 752 are provided to the output generation subsystem 180 of FIG. 1, an external dashboard, a storage system, an order-management system, an execution-management system, or another downstream system. In certain embodiments, the one or more allocation outputs 752 may be used to generate one or more portfolio recommendations, rebalance suggestions, trade lists, hedge overlays, exposure reports, or execution-related outputs.

In certain embodiments, the recognition-based portfolio allocation process 700 provides a technical improvement by converting one or more raw asset-evaluation magnitudes into bounded weighting factors that can be integrated more consistently across heterogeneous assets and market conditions.

In certain implementations, this can reduce instability associated with extreme raw performance scores, support computationally efficient closed-form weighting logic, and permit unified use of forecast, risk, sentiment, and performance information within a single portfolio-allocation framework.

In certain embodiments, the recognition-based portfolio allocation process 700 may operate periodically, continuously, on demand, event-driven, or according to one or more scheduled rebalance intervals. In certain embodiments, different sets of asset-evaluation values 722 may be used for different horizons, mandates, asset classes, or portfolio styles. In certain embodiments, one or more outputs of the recognition-based portfolio allocation process 700 may be stored, versioned, logged, or associated with one or more timestamps, confidence values, or audit records.

Although FIG. 7 illustrates one exemplary recognition-based portfolio allocation process 700, the disclosed subject matter is not limited to the arrangement shown. One or more stages may be omitted, reordered, repeated, or supplemented. One or more evaluation values may be scalar, vector, matrix-based, or composite. One or more allocation outputs may correspond to long-only portfolios, long-short portfolios, hedge overlays, sector allocations, basket allocations, or other exposure structures.

FIG. 8 illustrates an exemplary computing environment 800 for implementing the financial market prediction system 100 and the associated methods and processes described herein. In the illustrated embodiment, the computing environment 800 includes one or more processors 810, one or more memories 820, one or more storage devices 830, one or more market-data interfaces 840, one or more external-data interfaces 850, one or more communication interfaces 860, and one or more output interfaces 870 coupled by one or more buses, interconnects, fabrics, or communication pathways 880.

The one or more processors 810 are configured to execute instructions, perform calculations, process data, and control operation of the computing environment 800. In various embodiments, the one or more processors 810 may include one or more central processing units, graphics processing units, digital signal processors, hardware accelerators, field-programmable gate arrays, application-specific integrated circuits, vector processors, tensor processors, or combinations thereof. In certain embodiments, different portions of the disclosed subject matter may be assigned to different processor types according to latency, throughput, cost, or deployment requirements.

The one or more memories 820 are configured to store executable instructions, temporary values, intermediate values, configuration parameters, cached results, and other information used by the computing environment 800. In various embodiments, the one or more memories 820 may include volatile memory, non-volatile memory, random-access memory, read-only memory, cache memory, buffer memory, or other machine-readable memory structures.

The one or more storage devices 830 are configured to store persistent data associated with operation of the financial market prediction system 100. In various embodiments, the one or more storage devices 830 may store historical market data 832, external data 834, derived analytical data 836, configuration data 838, and output or audit data 839. The historical market data 832 may include prices, returns, quotes, trades, spreads, yield-related values, volatility-related values, order-book-related values, and other time-series market information. The external data 834 may include sentiment-bearing data, event data, macroeconomic data, and alternative data. The derived analytical data 836 may include network values, forecast values, risk values, sentiment values, transformed quantities, and allocation values. The configuration data 838 may include selected horizons, thresholds, mappings, asset universes, and system settings. The output or audit data 839 may include reports, alerts, logs, allocation records, signal histories, and transmitted messages.

The one or more market-data interfaces 840 are configured to receive or otherwise obtain one or more market-data feeds 842. In various embodiments, the one or more market-data feeds 842 may include exchange feeds, broker feeds, vendor feeds, pricing feeds, options feeds, fixed-income feeds, digital-asset feeds, index feeds, trade and quote feeds, or other market-related data streams. In certain embodiments, the one or more market-data interfaces 840 support batch acquisition, streaming acquisition, event-driven acquisition, request-driven acquisition, or combinations thereof.

The one or more external-data interfaces 850 are configured to receive or otherwise obtain one or more external-data feeds 852. In various embodiments, the one or more external-data feeds 852 may include news feeds, social-media feeds, analyst feeds, macroeconomic feeds, event feeds, fundamentals feeds, blockchain-related feeds, regulatory feeds, or other non-price information feeds relevant to one or more operations of the financial market prediction system 100.

The one or more communication interfaces 860 are configured to communicate with one or more external systems 862. In various embodiments, the one or more external systems 862 may include one or more client devices, servers, cloud services, order-management systems, execution-management systems, databases, dashboards, reporting engines, alerting systems, theorem-proving systems, or other computing systems. In certain embodiments, the one or more communication interfaces 860 support one or more wired protocols, wireless protocols, internet protocols, local-area network protocols, wide-area network protocols, message-bus protocols, application programming interfaces, or combinations thereof.

The one or more output interfaces 870 are configured to provide one or more system outputs 872. In various embodiments, the one or more system outputs 872 may include market forecasts, directional signals, confidence values, risk values, sentiment values, network values, allocation values, alerts, reports, dashboards, watchlists, rebalance instructions, execution-related messages, stored files, or streamed outputs. In certain embodiments, the one or more output interfaces 870 may provide outputs to a display, storage destination, application programming interface, communication channel, message bus, order-routing destination, or another downstream destination.

In the illustrated embodiment, the one or more memories 820 store instructions that, when executed by the one or more processors 810, implement a data ingestion engine 822, a preprocessing engine 824, a network engine 826, a predictive analytics engine 828, a sentiment engine 829, a risk engine 831, a portfolio engine 833, and an output engine 835. In certain embodiments, the data ingestion engine 822 corresponds to at least a portion of the data ingestion subsystem 110 of FIG. 1. In certain embodiments, the preprocessing engine 824 corresponds to at least a portion of the preprocessing subsystem 120 of FIG. 1. In certain embodiments, the network engine 826 corresponds to at least a portion of the recognition-based financial network subsystem 130 of FIG. 1. In certain embodiments, the predictive analytics engine 828 corresponds to at least a portion of the recognition-informed predictive analytics subsystem 140 of FIG. 1. In certain embodiments, the sentiment engine 829 corresponds to at least a portion of the recognition-based sentiment integration subsystem 150 of FIG. 1. In certain embodiments, the risk engine 831 corresponds to at least a portion of the recognition-based risk quantification subsystem 160 of FIG. 1. In certain embodiments, the portfolio engine 833 corresponds to at least a portion of the recognition-based portfolio allocation subsystem 170 of FIG. 1. In certain embodiments, the output engine 835 corresponds to at least a portion of the output generation subsystem 180 of FIG. 1.

In operation, the one or more market-data interfaces 840 and the one or more external-data interfaces 850 supply data to the data ingestion engine 822 and the preprocessing engine 824. The preprocessing engine 824 generates one or more prepared inputs for downstream use by the network engine 826, the predictive analytics engine 828, the sentiment engine 829, the risk engine 831, and the portfolio engine 833. One or more outputs from these engines are provided to the output engine 835, which generates one or more system outputs 872 for delivery through the one or more output interfaces 870 or for storage in the one or more storage devices 830.

In certain embodiments, the computing environment 800 implements one or more recognition-based transformations using a recognition coverage function stored as executable logic, arithmetic instructions, fixed-point logic, floating-point logic, lookup logic, or hardware-accelerated logic. In one embodiment, the recognition coverage function is defined in plain-text form as F_cov(r)=r/(r+X_opt), where X_opt is a positive scale constant. In certain preferred embodiments, X_opt=phi/pi.

In certain embodiments, one or more engines of the computing environment 800 apply the recognition coverage function to one or more non-negative inputs associated with network construction, predictive scaling, sentiment integration, risk quantification, or portfolio weighting.

In certain embodiments, the computing environment 800 may be implemented as a single computing device, a server system, a distributed computing system, a cloud-based system, a co-located trading system, an enterprise platform, or a hybrid architecture. In certain embodiments, one or more of the engines stored in the one or more memories 820 may be executed on different machines, in different containers, in different services, or in different processing domains. In certain embodiments, one or more data stores may be centralized, replicated, sharded, local, remote, or distributed.

In certain embodiments, the computing environment 800 may support real-time operation, near-real-time operation, scheduled batch operation, replay operation, simulation operation, paper-trading operation, back-testing operation, or combinations thereof. In certain embodiments, one or more outputs may be generated intraday, end-of-day, event-driven, at selected intervals, or in response to one or more trigger conditions.

In certain embodiments, the computing environment 800 is configured to process live market feeds under latency constraints associated with intraday or event-driven forecasting. In certain implementations, different engines may be assigned different execution cadences, priority levels, or hardware resources so that graph updates, derivative forecasting, sentiment processing, risk processing, and allocation processing can proceed in parallel or partially overlapping fashion.

In certain embodiments, the computing environment 800 includes one or more quality-control or fault-handling routines configured to detect stale inputs, missing inputs, malformed records, synchronization failures, or inconsistent subsystem states. In certain embodiments, upon detecting such a condition, the system may quarantine a record, apply a fallback transform input, skip a selected update cycle, mark an output as degraded, or suppress transmission of a selected output.

In certain embodiments, the computing environment 800 includes one or more audit or replay capabilities for reproducing a previously generated network output, predictive output, risk output, sentiment output, or allocation output from stored input records, stored configuration values, and stored intermediate values.

In certain embodiments, the computing environment 800 may further include one or more validation or assurance components 890. The one or more validation or assurance components 890 may be configured to test, verify, certify, or otherwise evaluate one or more mathematical, logical, or operational properties of one or more disclosed processes. In certain embodiments, the one or more validation or assurance components 890 may evaluate boundedness, monotonicity, consistency, threshold conditions, output integrity, or processing correctness. In certain embodiments, the one or more validation or assurance components 890 may include symbolic tools, theorem-proving tools, rule-based validators, or test harnesses.

In certain embodiments, the computing environment 800 provides a technical implementation framework supporting the financial market prediction system 100 across a variety of hardware and software arrangements while preserving the ability to ingest heterogeneous data, compute recognition-transformed quantities, generate multiple analytical outputs, and route such outputs to downstream users or systems in an operationally useful form.

In certain embodiments, the disclosed subject matter provides technical improvements in computer-implemented financial data processing by transforming heterogeneous market-related inputs into bounded machine-usable values prior to downstream network generation, predictive processing, risk processing, sentiment processing, or allocation processing. In certain implementations, the use of the bounded recognition-based transform reduces sensitivity to unstable raw magnitudes, reduces propagation of extreme values across multiple processing stages, and improves numerical consistency when processing streaming or batch financial data.

In certain embodiments, the generation of the recognition-based financial network data structure and the predictive output from transformed derivative modifiers provides a concrete machine-processing architecture in which market data is not merely analyzed at a high level, but is converted into structured graph representations, transformed derivative values, bounded subsystem outputs, and machine-generated outputs suitable for storage, transmission, display, ranking, alerting, or downstream execution-related processing.

In certain embodiments, the disclosed subject matter improves interoperability among subsystems by using a common bounded transform across graph construction, derivative scaling, sentiment processing, risk processing, and allocation processing. In certain implementations, this common transform reduces re-normalization burden across subsystems and permits multiple heterogeneous inputs to be processed in a more computationally consistent framework.

Although FIG. 8 illustrates one exemplary computing environment 800, the disclosed subject matter is not limited to the arrangement shown. One or more components may be omitted, combined, subdivided, replicated, distributed, virtualized, accelerated, or otherwise modified. One or more operations may be performed in software, hardware, firmware, or combinations thereof. One or more components may be local or remote. One or more outputs may be consumed by human operators, automated systems, external platforms, or combinations thereof.

In the foregoing description, one or more embodiments of the disclosed subject matter have been described with reference to recognition-based financial forecasting operations, recognition-based network construction, recognition-informed predictive analytics, recognition-based sentiment integration, recognition-based risk quantification, and recognition-based portfolio allocation. Additional implementation details, interpretation principles, and exemplary embodiments will now be described.

As used herein, the term “recognition-based” refers to the use of one or more bounded transforms, scaling operations, or analytical mappings derived from or consistent with a recognition-theoretic framework to regulate the influence of one or more market-related inputs within a financial forecasting or decision-support process. In certain preferred embodiments, the bounded transform comprises a recognition coverage function F_cov(r)=r/(r+X_opt), where r is a non-negative input quantity and X_opt is a positive scale constant. In certain preferred embodiments, X_opt=phi/pi. However, the disclosed subject matter is not limited to a single implementation form, provided that the resulting processing remains consistent with the bounded recognition-based treatment described herein.

As used herein, the term “financial instrument” may include any equity, debt instrument, bond, note, future, option, swap, currency pair, commodity instrument, digital asset, exchange-traded product, index-linked instrument, basket, portfolio component, derivative-linked product, or other tradable or analyzable market entity. The term “asset” may be used interchangeably with “financial instrument” in certain embodiments. The term “market variable” may include any observed, derived, estimated, predicted, normalized, transformed, or otherwise processed quantity associated with one or more financial instruments or market states.

As used herein, the term “dependency measure” refers to any quantity representative of a relationship between two or more financial instruments, entities, sectors, factors, or market states. A dependency measure may include a correlation, covariance-derived value, lagged relationship measure, factor-adjusted relationship measure, similarity score, influence score, or another selected inter-entity relationship quantity. The term “pairwise coupling quantity” refers to any non-negative quantity used to modulate the strength of a relationship between two entities through a recognition-based transform, including volatility combinations, liquidity-related values, spread-related values, stress-related values, or other selected coupling-related inputs.

As used herein, the term “sentiment-bearing input” refers to any input from which a sentiment-related, opinion-related, tone-related, confidence-related, or event-impact-related value can be derived. Such inputs may include textual materials, event descriptors, source-tagged information, analyst signals, social signals, market commentary, earnings-call content, macroeconomic release commentary, or any other informational input suitable for sentiment or event evaluation.

As used herein, the term “risk-related input” refers to any input associated with realized or potential downside, instability, uncertainty, illiquidity, contagion, discontinuity, or adverse market movement. Such inputs may include volatility values, spread values, liquidity values, drawdown values, contagion values, event-stress values, graph-related stress values, or any other quantity suitable for risk evaluation.

As used herein, the term “asset-evaluation value” refers to any quantity used to assess one or more assets or instruments for purposes of allocation, ranking, filtering, weighting, or rebalancing. Such values may include performance-related quantities, Sharpe-related quantities, risk-adjusted values, forecast-related values, confidence-related values, sentiment-adjusted values, momentum-related values, or other selected metrics.

In certain embodiments, one or more raw values used by the disclosed subject matter are transformed into one or more recognition-compatible values before application of a recognition coverage function. This transformation may be used where a raw input is signed, unbounded, noisy, dimensioned, non-stationary, or otherwise unsuitable for direct application of a bounded transform.

In one embodiment, a raw input x_raw may be transformed into a recognition-compatible value r using a preprocessing function h, expressed in plain-text form as r=h(x_raw). The preprocessing function h may include clipping, scaling, shifting, smoothing, rolling normalization, ranking, percentile conversion, volatility normalization, liquidity normalization, magnitude extraction, or another selected transformation.

In certain embodiments, signed inputs are processed using a sign-preserving recognition-based transform in which the magnitude of the signed input is recognition-scaled and the sign is retained. In one embodiment, a signed transformed value may be represented in plain-text form as F_signed(x)=sign(x)*abs(x)/(abs(x)+X_opt). This sign-preserving form may be useful for directional sentiment inputs, long-short allocation inputs, signed spread expectations, signed return expectations, or signed network-edge embodiments.

In certain embodiments, the recognition coverage function is used as a preferred implementation because it provides a bounded monotone response and can be computed using a relatively simple closed-form expression. However, the disclosed subject matter is not limited to a single exact mathematical realization in all embodiments. In certain embodiments, a functionally similar bounded recognition-compatible mapping may be used where appropriate for selected hardware, precision, speed, or implementation requirements, provided that the operation remains within the scope of the disclosed recognition-based processing framework.

In certain embodiments, the one or more weighting values used to combine subsystem outputs, including values such as alpha, beta, gamma, a, b, c, and d as described above, may be fixed, adaptive, normalized, confidence-derived, source-derived, performance-derived, or system-defined. In certain embodiments, such weighting values may be selected according to configuration settings, rolling performance logic, recency logic, agreement logic, regime logic, or other selected system behavior. In certain other embodiments, subsystem outputs are not reduced to a single scalar value and are instead output as a tuple, vector, ranked list, structured record, or multi-component decision object.

In certain embodiments, the disclosed subject matter may be implemented for different time horizons, including tick-level, intraday, end-of-day, daily, weekly, monthly, or event-driven forecasting horizons. In certain embodiments, a plurality of horizons may be processed simultaneously, and one or more outputs may be horizon-specific, horizon-ranked, or cross-horizon aggregated. In certain embodiments, a first subsystem may operate at a first cadence and a second subsystem may operate at a second cadence. For example, a sentiment subsystem may update on an event-driven basis while a portfolio allocation subsystem updates on a periodic basis.

In certain embodiments, the disclosed subject matter may be applied across different asset classes and market types, including equities, exchange-traded products, bonds, rates, futures, commodities, foreign exchange instruments, options-related underlyings, digital assets, baskets, sectors, indices, and combinations thereof. In certain embodiments, different preprocessing logic, risk logic, dependency logic, or allocation logic may be used for different asset classes while still employing the same recognition-based framework.

In certain embodiments, the disclosed subject matter may operate in a forecasting-only mode, an analytics-only mode, an alerting mode, a portfolio-recommendation mode, a rebalance mode, a risk-overlay mode, a paper-trading mode, or an execution-linked mode. In certain embodiments, one or more outputs are informational and are displayed, logged, or transmitted without direct trading action. In certain embodiments, one or more outputs are used to generate or support one or more trade lists, hedge instructions, rebalance proposals, or execution-related messages.

In certain embodiments, the disclosed subject matter may further include one or more worked computational examples. In one example, a network edge between two assets may be computed by determining a dependency measure Corr(i,j,t), determining a non-negative pairwise coupling quantity V_ij(t), computing F_cov(V_ij(t)), and multiplying the dependency measure by the transformed coupling value to produce S_ij(t). In another example, a forecast value may be computed by determining a first derivative term, determining a second derivative term, recognition-scaling one or both derivative terms using one or more modifier inputs, and computing a next-horizon estimate using the resulting transformed derivative quantities.

In another example, a sentiment output may be computed by receiving one or more sentiment-bearing inputs, determining one or more raw sentiment values, optionally aggregating the raw sentiment values across sources or time, and applying a recognition-based transform to obtain a bounded sentiment output. In another example, a risk output may be computed by receiving one or more volatility-related, liquidity-related, drawdown-related, or contagion-related inputs and applying the recognition coverage function to one or more such inputs to obtain one or more bounded risk quantities. In another example, a portfolio allocation may be computed by determining one or more asset-evaluation values, applying a recognition-based weighting step to generate intermediate allocation values, and normalizing the intermediate allocation values to obtain one or more final allocation outputs.

Verification metrics. In certain embodiments, the system computes at least one objective forecast-quality metric for a selected horizon Delta T, including (i) directional hit rate (fraction of instances where sign(P_pred(t+Delta T)−P(t)) matches sign(P(t+Delta T)−P(t))), (ii) mean absolute percentage error (MAPE), (iii) root mean squared error (RMSE), (iv) correlation between predicted returns and realized returns over a rolling window, and/or (v) strategy-level Sharpe ratio computed from signals produced by the predictive output.

Acceptance criteria. In one embodiment, a predictive output is designated “accepted” when (i) hit rate over a rolling window W exceeds a threshold H_min and (ii) MAPE is below a threshold E_max.

Example thresholds. In one embodiment, W is between 20 and 250 samples, H_min is between 0.52 and 0.65, and E_max is between 0.5% and 5% depending on asset class and cadence.

Gating action. If the acceptance criteria are not met, the output generation subsystem suppresses trading/execution actions, reduces an exposure scalar, increases a risk overlay, and/or lowers a confidence value associated with the predictive output.

Update action. In certain embodiments, when acceptance criteria are not met for N_fail consecutive windows, the system adjusts at least one operational parameter, including a sampling interval, a rolling-window length, a dependency estimation window, a network threshold τ, and/or fusion weights α, β, γ, and then recomputes outputs.

Audit record. In certain embodiments, the computed metrics, thresholds, pass/fail state, and any parameter adjustment are stored as audit data in the data store.

In certain embodiments, one or more mathematical, logical, or operational properties of the disclosed subject matter may be validated or checked. For example, one or more implementations may verify that a transformed value remains within an expected range, that a weighting value satisfies one or more selected conditions, that an output record is internally consistent, or that one or more threshold rules are correctly applied. In certain embodiments, such validation may be performed by a theorem-proving system, symbolic validator, rule engine, testing framework, or another assurance mechanism. In certain preferred embodiments, such validation is optional and supplemental rather than required for all implementations.

In certain embodiments, the disclosed subject matter provides technical benefits by permitting multiple heterogeneous market-related quantities to be processed using a common bounded recognition-based analytical framework. In certain embodiments, such an approach can reduce instability associated with large or poorly normalized raw magnitudes, provide consistent scaling behavior across subsystems, support computationally efficient closed-form operations, improve interoperability among forecasting, risk, sentiment, and allocation functions, and support deployment across a variety of machine-implemented computing environments.

It will be understood that the components, steps, equations, relationships, and configurations described herein are illustrative and not limiting. One or more modules may be combined or separated. One or more equations may be modified, approximated, discretized, vectorized, parallelized, or otherwise implemented according to engineering choice. One or more thresholds may be preset, adaptive, learned, configured, derived, or omitted. One or more steps may occur in a different order unless a particular order is expressly required. One or more features described in connection with one embodiment may be used in connection with another embodiment.

It will further be understood that singular terms may include plural referents and plural terms may include singular referents unless the context clearly indicates otherwise. Terms such as “including,” “comprising,” “having,” and similar expressions are intended to be open-ended unless expressly stated otherwise. References to “one embodiment,” “certain embodiments,” “an embodiment,” or similar language indicate that a particular feature may be included in at least one embodiment, but such language does not require that the feature be present in all embodiments.

The foregoing description is intended to illustrate rather than limit the disclosed subject matter. Variations, modifications, substitutions, and alternative implementations will be apparent to those of ordinary skill in the art in view of the present disclosure. Accordingly, the disclosed subject matter is intended to embrace all such alternatives, modifications, and variations as fall within the scope of the appended claims.

What is claimed is:

1. A computer-implemented method for enhanced financial forecasting and market movement prediction, the method comprising:
receiving, by one or more processors, market data associated with a plurality of financial instruments;
determining, by the one or more processors from the market data, one or more dependency values associated with relationships among the plurality of financial instruments;
determining, by the one or more processors from the market data, one or more pairwise coupling quantities associated with the plurality of financial instruments;
applying, by the one or more processors, a bounded recognition-based transform to the one or more pairwise coupling quantities to generate one or more transformed coupling values;
generating, by the one or more processors, a recognition-based financial network data structure representing structural relationships among the plurality of financial instruments using the one or more dependency values and the one or more transformed coupling values;
determining, by the one or more processors from at least one target market variable, a first derivative quantity and a second derivative quantity associated with the at least one target market variable;
applying, by the one or more processors, the bounded recognition-based transform to a volatility-related modifier input and a liquidity-related modifier input associated with the at least one target market variable to generate a transformed first-derivative modifier and a transformed second-derivative modifier;
generating, by the one or more processors, a predictive output associated with the at least one target market variable using the first derivative quantity, the second derivative quantity, the transformed first-derivative modifier, and the transformed second-derivative modifier; and
outputting, by the one or more processors, at least one machine-generated market forecast or market movement prediction based on the recognition-based financial network data structure and the predictive output.

2. The method of claim 1, wherein the bounded recognition-based transform comprises a monotone transform configured to map a non-negative input into a bounded output range to reduce numerical instability caused by extreme input magnitudes during streaming computation of at least one of network edge weights or derivative-based scaling.

3. The method of claim 2, wherein the bounded recognition-based transform is defined by a recognition coverage function F_cov(r)=r/(r+X_opt), where r is a non-negative input quantity and X_opt is a positive scale constant.

4. The method of claim 3, wherein X_opt=phi/pi.

5. The method of claim 1, wherein determining the one or more dependency values comprises determining at least one of a correlation value, a covariance-derived value, a lagged dependency value, or a factor-adjusted dependency value, and wherein the correlation value is computed over a rolling window W_corr between 20 and 500 samples.

6. The method of claim 1, wherein determining the one or more pairwise coupling quantities comprises determining at least one of a volatility-related quantity, a liquidity-related quantity, a spread-related quantity, or a stress-related quantity, and wherein generating the recognition-based financial network data structure comprises generating at least one edge value using a product of (i) at least one of the one or more dependency values and (ii) at least one of the one or more transformed coupling values.

7. The method of claim 1, further comprising receiving one or more sentiment-bearing inputs, determining one or more sentiment values from the one or more sentiment-bearing inputs, applying the bounded recognition-based transform to the one or more sentiment values to generate one or more bounded sentiment outputs, and modifying the at least one machine-generated market forecast or market movement prediction based on the one or more bounded sentiment outputs, wherein determining the one or more sentiment values comprises aggregating sentiment information over a time window to generate a sentiment score associated with the at least one target market variable.

8. The method of claim 7, wherein the one or more sentiment-bearing inputs comprise at least one of news-derived inputs, social-media-derived inputs, analyst-derived inputs, or event-derived inputs.

9. The method of claim 1, further comprising determining one or more risk-related inputs from the market data, applying the bounded recognition-based transform to the one or more risk-related inputs to generate one or more bounded risk outputs, and modifying at least one of the machine-generated market forecast, the market movement prediction, or an alert condition based on the one or more bounded risk outputs, wherein modifying comprises generating the alert condition when at least one bounded risk output satisfies a threshold condition.

10. The method of claim 9, wherein the one or more risk-related inputs comprise at least one of a volatility-related input, a liquidity-related input, a drawdown-related input, a contagion-related input, or a spread-related input.

11. The method of claim 1, further comprising determining one or more asset-evaluation values associated with at least a subset of the plurality of financial instruments, applying the bounded recognition-based transform to the one or more asset-evaluation values to generate one or more transformed asset-evaluation values, generating one or more intermediate allocation values using the one or more transformed asset-evaluation values, and normalizing the one or more intermediate allocation values to generate one or more allocation outputs, wherein normalizing comprises scaling the one or more intermediate allocation values such that the allocation outputs sum to a predetermined total allocation value.

12. The method of claim 11, wherein the one or more asset-evaluation values comprise at least one of a performance-related value, a forecast-related value, a risk-adjusted value, a sentiment-adjusted value, or a momentum-related value.

13. The method of claim 1, further comprising generating a confidence output based on agreement among a plurality of subsystem outputs, wherein generating the confidence output comprises computing at least one forecast-quality metric over a rolling window and designating the predictive output as accepted when (i) a hit rate over the rolling window exceeds a threshold H_min and (ii) a mean absolute percentage error (MAPE) over the rolling window is below a threshold E_max, and wherein the method further comprises, when the predictive output is not accepted, suppressing at least one downstream action and storing audit data including the at least one forecast-quality metric, the threshold values, and an acceptance state, and when the predictive output is not accepted for N_fail consecutive windows, adjusting at least one operational parameter.

14. A system for enhanced financial forecasting and market movement prediction, the system comprising:
one or more processors; and
one or more memories storing instructions that, when executed by the one or more processors, cause the system to:
receive market data associated with a plurality of financial instruments;
determine from the market data one or more dependency values associated with relationships among the plurality of financial instruments;
determine from the market data one or more pairwise coupling quantities associated with the plurality of financial instruments;
apply a bounded recognition-based transform to the one or more pairwise coupling quantities to generate one or more transformed coupling values;
generate a recognition-based financial network data structure representing structural relationships among the plurality of financial instruments using the one or more dependency values and the one or more transformed coupling values;
determine from at least one target market variable a first derivative quantity and a second derivative quantity associated with the at least one target market variable;
apply the bounded recognition-based transform to a volatility-related modifier input and a liquidity-related modifier input associated with the at least one target market variable to generate a transformed first-derivative modifier and a transformed second-derivative modifier;
generate a predictive output associated with the at least one target market variable using the first derivative quantity, the second derivative quantity, the transformed first-derivative modifier, and the transformed second-derivative modifier; and
output at least one machine-generated market forecast or market movement prediction based on the recognition-based financial network data structure and the predictive output.

15. The system of claim 14, wherein the bounded recognition-based transform comprises a monotone transform configured to map a non-negative input into a bounded output range to reduce numerical instability caused by extreme input magnitudes during streaming computation of at least one of network edge weights or derivative-based scaling.

16. The system of claim 15, wherein the bounded recognition-based transform is defined by a recognition coverage function F_cov(r)=r/(r+X_opt), where r is a non-negative input quantity and X_opt is a positive scale constant.

17. The system of claim 14, wherein the instructions further cause the system to receive one or more sentiment-bearing inputs, determine one or more sentiment values from the one or more sentiment-bearing inputs, apply the bounded recognition-based transform to the one or more sentiment values to generate one or more bounded sentiment outputs, and modify the at least one machine-generated market forecast or market movement prediction based on the one or more bounded sentiment outputs, wherein determining the one or more sentiment values comprises aggregating sentiment information over a time window to generate a sentiment score associated with the at least one target market variable.

18. The system of claim 14, wherein the instructions further cause the system to determine one or more risk-related inputs from the market data, apply the bounded recognition-based transform to the one or more risk-related inputs to generate one or more bounded risk outputs, and modify at least one of the machine-generated market forecast, the market movement prediction, or an alert condition based on the one or more bounded risk outputs, wherein modifying comprises generating the alert condition when at least one bounded risk output satisfies a threshold condition.

19. A non-transitory computer-readable medium storing instructions that, when executed by one or more processors, cause the one or more processors to perform operations comprising:
receiving market data associated with a plurality of financial instruments;
determining from the market data one or more dependency values associated with relationships among the plurality of financial instruments;
determining from the market data one or more pairwise coupling quantities associated with the plurality of financial instruments;
applying a bounded recognition-based transform to the one or more pairwise coupling quantities to generate one or more transformed coupling values;
generating a recognition-based financial network data structure representing structural relationships among the plurality of financial instruments using the one or more dependency values and the one or more transformed coupling values;
determining from at least one target market variable a first derivative quantity and a second derivative quantity associated with the at least one target market variable;
applying the bounded recognition-based transform to a volatility-related modifier input and a liquidity-related modifier input associated with the at least one target market variable to generate a transformed first-derivative modifier and a transformed second-derivative modifier;
generating a predictive output associated with the at least one target market variable using the first derivative quantity, the second derivative quantity, the transformed first-derivative modifier, and the transformed second-derivative modifier; and
outputting at least one machine-generated market forecast or market movement prediction based on the recognition-based financial network data structure and the predictive output.

20. The non-transitory computer-readable medium of claim 19, wherein the operations further comprise determining one or more asset-evaluation values associated with at least a subset of the plurality of financial instruments, applying the bounded recognition-based transform to the one or more asset-evaluation values to generate one or more transformed asset-evaluation values, generating one or more intermediate allocation values using the one or more transformed asset-evaluation values, and normalizing the one or more intermediate allocation values to generate one or more allocation outputs, wherein normalizing comprises scaling the one or more intermediate allocation values such that the allocation outputs sum to a predetermined total allocation value.
